(19) United States
(12) Patent Application Publication
(10) Pub. No.: US 2026/0097434 A1
(43) Pub. Date: Apr. 9, 2026

(54) FEEDFORWARD CONTROL OF LASER POWDER BED FUSION

(71) Applicant: NUtech Ventures, Lincoln, NE (US)

(72) Inventors: Alex RIENSCHE, Lincoln, NE (US); Prahalada RAO, Lincoln, NE (US); Benjamin BEVANS, Lincoln, NE (US); Kevin D. COLE, Lincoln, NE (US); Reza YAVARI, Lincoln, NE (US)

(21) Appl. No.: 18/994,845

(22) PCT Filed: Jul. 28, 2023
(86) PCT No.: PCT/US2023/028995

§ 371 Date: Jan. 15, 2025

Related U.S. Application Data
(60) Provisional application No. 63/393,721, filed on Jul. 29, 2022.

(51) Int. Cl. B22F 10/85; B22F 10/28; B22F 10/36; B22F 12/90; B33Y 50/02

(52) U.S. Cl. CPC B22F 10/85; B22F 10/28; B22F 10/36; B22F 12/90; B33Y 50/02; B22F 2203/11; B22F 2998/10

(57) ABSTRACT

Methods, systems, and apparatus, including computer programs encoded on computer storage media, for controlled laser powder bed fusion (LPBF) metal additive manufacturing. One of the methods includes predicting thermal information of a part to be printed; analyzing the thermal information to identify one or more areas of potential heat buildup; and adjusting process parameters for processing the identified one or more areas to reduce heat buildup.

### CROSS-REFERENCE TO RELATED APPLICATION

This application claims the benefit of U.S. Provisional Application No. 63/393,721, filed Jul. 29, 2022, the contents of which are incorporated by reference herein

### BACKGROUND

Despite demonstrated potential to reduce lead time and overcome design-related constraints, laser powder bed fusion (LPBF) has yet to displace conventional manufacturing, particularly in precision-driven industries, owing to its tendency to create flaws, which eventually leads to large variability in functional properties. The spatiotemporal temperature distribution in the part during the LPBF process, also called the thermal history, is reported to be the major cause of such flaw formation scenarios as sub-standard geometric integrity; poor surface finish; build failures, e.g., recoater crashes and collapse of supports; cracking and distortion; inconsistent microstructure, among others. Therefore, new methods that result in improved geometric integrity and surface finish as well as stable builds and consistent microstructures are desirable.

### SUMMARY

One technique described in this document is to develop and apply a model-driven feedforward control approach for mitigating thermal-induced flaw formation in metal parts made using laser powder bed fusion (LPBF) process. Temperature predictions from a physics-based computational simulation model are used to adjust the processing parameters layer-by-layer before, or while, a part is printed with the intent of avoiding heat buildup and subsequently reducing thermal-induced flaw formation. These techniques can replace cumbersome and expensive build-and-test empirical optimization.

In general, one aspect of the subject matter described in this specification can be embodied in methods that include the actions of predicting thermal information of a part to be printed; analyzing the thermal information to identify one or more areas of potential heat buildup; and adjusting process parameters for processing the identified one or more areas to reduce heat buildup.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, predicting the thermal information of the part that is to be printed includes: generating a result using a graph theory-based thermal model, wherein the result represents the thermal information of the part. In some implementations, actions include generating the graph theory-based thermal model, wherein generating the graph theory-based thermal model includes determining nodes representing portions of the part; and generating one or more values, included in the graph theory-based thermal model, representing one or more connections between the nodes.

In some implementations, the thermal information includes one or more temperature distributions. In some implementations, the one or more areas of potential heat buildup include a layer of the part. In some implementations, adjusting the process parameters for processing the identified one or more areas to reduce heat buildup includes adjusting the process parameters during a laser powder bed fusion additive manufacturing process. In some implementations, during a laser powder bed fusion additive manufacturing process includes between manufactured layers. In some implementations, the areas of potential heat buildup include areas that satisfy a threshold temperature difference. In some implementations, the threshold temperature difference is measured between a current layer of the part and a successive layer of the part. In some implementations, the threshold temperature difference is at least twenty degrees Celsius. In some implementations, the process parameters include a power level of a laser for a laser powder bed fusion additive manufacturing process.

In some implementations, the process parameters include a time delay representing a time between manufacturing layers in a powder bed fusion additive manufacturing process. In some implementations, the part is at least partially printed before predicting the thermal information.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic of a laser powder bed fusion (LPBF) metal additive manufacturing process.

FIG. 1B shows examples of flaw formations from a LPBF process.

FIG. 2 shows an example process of model-driven feed forward control of additive manufacturing.

FIG. 3A shows a schematic of an LPBF system.

FIG. 3B shows a photograph of an LPBF system.

FIG. 4A shows a top view of a build plate with detailed view of geometries created in this work with four geometries analyzed in depth.

FIG. 4B shows an actual fixed processing build plate upon completion.

FIG. 5 shows four parts selected for analysis, underlying rationale, and post-process characterization.

FIG. 6 shows a correlation between time between layers (TBL), also referred to as inter-layer time (ILT), and build height and layers.

FIG. 7 shows calibration functions for converting the IR thermal camera readings to absolute temperature measurements.

FIG. 8 shows surface temperature images obtained from an IR camera during a fixed processing build.

FIG. 9 shows an example of obtaining end-of-cycle surface temperature from an IR camera.

FIG. 10 shows observed surface temperature from an IR camera plotted as a function of layer height.

FIG. 11 shows an application of graph theory thermal modeling in LPBF with multiple steps in simulating the thermal history of the frame part.

FIG. 12 shows an example calibration of graph theory parameters, node density (n) and super layer thickness(s) using the cone part as reference.

FIG. 13 shows a model-driven feedforward control of additive manufacturing approach applied to a cone-shaped part.

FIG. 14 shows porosity levels (DVR) from X-ray CT and relative density (ρrel) from Archimedes measurements are plotted as a function of laser power (P) used for five the parameter cubes.

FIG. 15 shows a summary of process parameters adjusted for controlled processing of the four parts.

FIG. 16 shows a comparison of a model-derived end-of-cycle surface temperature trends with an IR-measured end-of-cycle surface temperature measurements for a cone-shaped part produced under fixed and controlled processing.

FIG. 17 shows a spatial temperature distribution for the cone part predicted using the graph theory thermal model for fixed processing and controlled processing.

FIG. 18 shows an X-ray computerized tomography (CT) and optical images of cone-shaped parts.

FIG. 19 shows a primary dendritic arm spacing (λ1) measured along the build height for the (a) fixed, and (b) controlled processing cone-shaped parts at four locations (A), (B), (C), and (D).

FIG. 20 shows primary dendritic arm spacing (λ1) for controlled processing (blue) and fixed processing (red) conditions at the four positions A-D demarcated in FIG. 19 and indicates the microhardness (HV0.5) is inversely related to λ1—the larger the grain size, the smaller the microhardness.

FIG. 21 shows a comparison of predicted and observed surface temperature for the vase-shaped parts.

FIG. 22 shows a visualization of the temperature distribution in the vase parts predicted by the graph theory modeling approach for the fixed- and controlled-processed scenarios.

FIG. 23 shows optical cross-section micrographs and nominal-to-actual X-ray CT dimensional analysis of the vase-shaped parts.

FIG. 24 shows thermal history at a fixed location (13 mm, layer 325) for (a) fixed processing, and (b) controlled processing.

FIG. 25 shows a comparison of observed and predicted surface temperature trends for the frame shape using (a) fixed processing and (b) controlled processing.

FIG. 26 shows a comparison of the temperature distribution between the fixed and controlled processing frame parts at select layers.

FIG. 27 shows an X-ray CT nominal-to-actual comparison for (a) fixed and (b) controlled processing.

FIG. 28 shows an effect of fixed and controlled processing on the thickness (width) of the wall of the frame.

FIG. 29 shows a comparison of the model derived surface temperature trends and IR data for (a) fixed processing, and (b) controlled processing.

FIG. 30 shows a comparison of the thermal history for fixed and controlled processing for the bridge.

FIG. 31 shows a comparison of the geometric resolution of (a) fixed and (b) controlled-processed bridge part.

FIG. 32 is a flow diagram of an example process for controlled laser powder bed fusion (LPBF) metal additive manufacturing.

Like reference numbers and designations in the various drawings indicate like elements.

### DETAILED DESCRIPTION

The techniques described include a model-driven feedforward control approach to mitigate thermal-induced flaw formation in laser powder bed fusion (LPBF) additive manufacturing process. One aspect of the techniques is to avert heat buildup in a LPBF part before it is fully printed by adapting process parameters layer-by-layer based on insights from a physics-based thermal simulation model. Techniques described can replace cumbersome empirical parameter optimization.

In some implementations, techniques include three steps. For example, the three steps can include: prediction, analysis, and correction. First, the temperature distribution of a part can be predicted using a graph theory-based computational thermal model. Second, the model-derived thermal trends can be analyzed to isolate layers of potential heat buildup. Third, heat buildup in affected layers can be corrected before printing by adjusting process parameters optimized through iterative simulations.

The effectiveness of the approach was demonstrated experimentally on two separate build plates. In the first build plate, termed fixed processing, ten different nickel alloy 718 parts were produced under constant processing conditions. On a second identical build plate, called controlled processing, the laser power and dwell time for each part was adjusted before printing based on thermal simulations to avoid heat buildup. To validate the thermal model predictions, the surface temperature of each part was tracked with a calibrated infrared thermal camera. Post-process the parts were examined with non-destructive and destructive materials characterization techniques. Compared to fixed processing, parts produced under controlled processing showed superior geometric accuracy and resolution, finer grain size, increased microhardness, and reduced surface roughness.

One technique described in this document is to develop and apply a model-driven feedforward control approach for mitigating thermal-induced flaw formation in metal parts made using laser powder bed fusion (LPBF) process. Temperature predictions from a physics-based computational simulation model can be used to adjust processing parameters layer-by-layer before, or while, a part is printed with the intent of avoiding heat buildup and subsequently reducing thermal-induced flaw formation. Techniques described can be used to replace, what can be cumbersome and expensive, build-and-test empirical optimization.

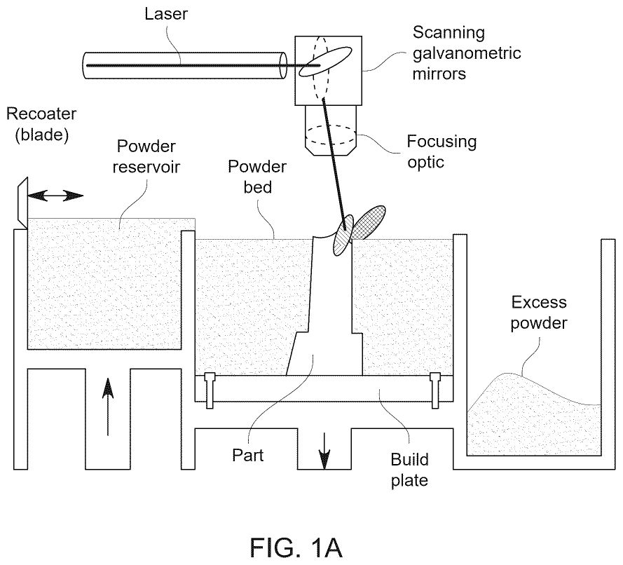

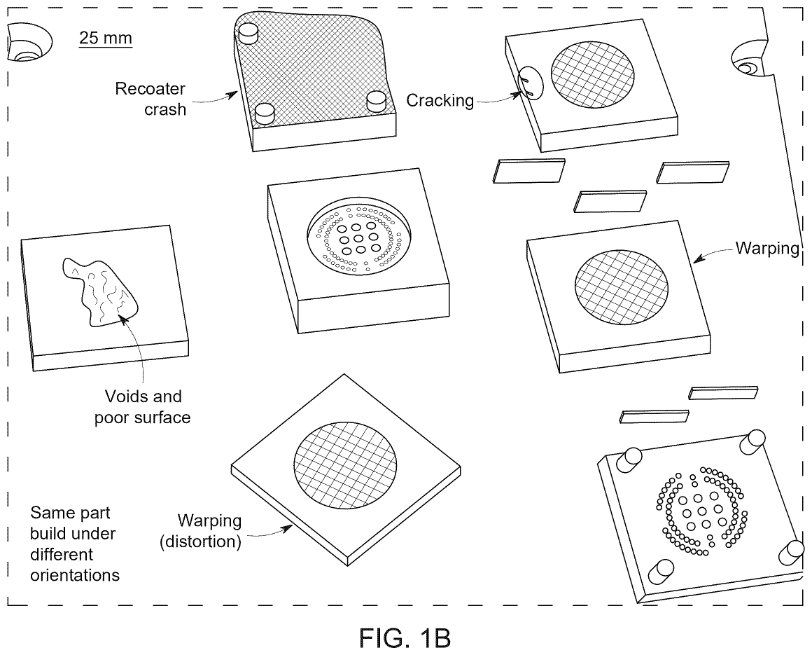

FIG. 1A is a schematic of a laser powder bed fusion (LPBF) metal additive manufacturing process. In LPBF, as shown in FIG. 1A, metal powder is raked or rolled onto a build plate and selectively melted layer-by-layer using energy from a laser. Despite its demonstrated potential to reduce lead time and overcome design-related constraints, LPBF has yet to displace conventional manufacturing, particularly in precision-driven industries. One reason for this is its tendency to create flaws, which eventually leads to large variability in functional properties.

FIG. 1B shows examples of flaw formations from a LPBF process. The LPBF process is prone to flaw formation despite extensive empirical optimization of processing parameters. For example, the same part when built under identical parameters in different orientations results in various types of flaws, such as warping, cracking, poor surface finish, and recoater crash.

The spatiotemporal temperature distribution in a part during an LPBF process, also called thermal history, can be a major cause of flaw formation scenarios-such as, sub-standard geometric integrity; poor surface finish; build failures—e.g., recoater crashes and collapse of supports; cracking and distortion; inconsistent microstructure, among others.

The thermal history of LPBF parts can be influenced by several factors such as: processing parameters; part design; part orientation, layout and build plan; other parts on the build plate; and feedstock materials aspects. The thermal history of a part may vary substantially from layer-to-layer due to a changing surface area of the part. Hence, thermal-induced flaw formation can occur despite using empirically optimized processing conditions.

The causal effect of thermal history on part quality is illustrated in FIG. 1B, which shows a LPBF build plate consisting of seven identical stainless steel parts printed under manufacturer-optimized processing conditions. The parts differ only in their orientation and were made under the same processing conditions that remained constant throughout the build. Out of the seven parts printed, only two were observed to be nominally flaw-free, the rest of the five parts were afflicted with thermal-induced flaws, such as cracking and warping.

The flaws exemplified in FIG. 1B can be attributed to existing empirical approaches to process optimization. In some current LPBF practice, simple cuboid or cylinder-shaped coupons are deposited under different processing conditions (e.g., laser power, velocity, hatch spacing, scan pattern). Subsequently, the test coupons are examined post-process, typically with non-destructive X-ray computed tomography and destructive metallographic analysis. Based on these empirical tests, practitioners can identify optimal processing parameters for obtaining a desired physical characteristic, such as porosity, part density, surface finish, or mechanical property, e.g., tensile strength.

Subjective geometry-specific, build-and-test empirical optimization is expensive and laborious given there are over 50 critical-to-quality LPBF process variables, prohibitive cost of powder feedstock materials, and small production batch sizes. Techniques described in this document outline alternatives to empirical process parameter optimization using a physics-guided strategy that encompasses the causal relationship between parameters, part design, thermal history and part quality.

In general, aspects of this document demonstrate that model-driven feedforward process control mitigates thermal-induced flaw formation in LPBF parts. In some implementations, feedforward control is used to avert heat buildup in an LPBF part by optimizing process parameters layer-by-layer before, or while, printing based on insight from a computational thermal simulation model.

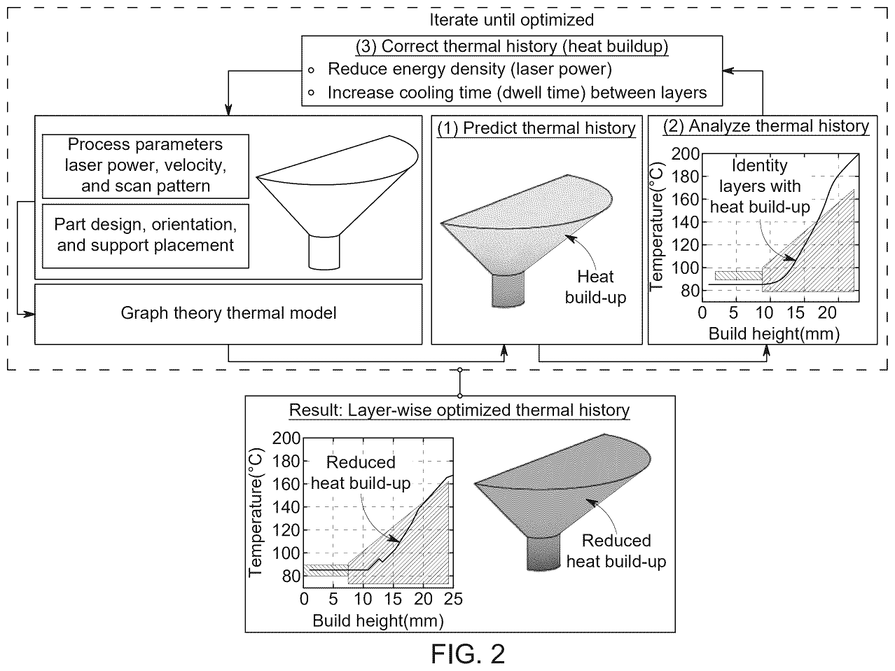

FIG. 2 shows an example process of model-driven feed forward control of additive manufacturing. This model-driven feed forward control of additive manufacturing approach includes three steps. (Step 1) Prediction of thermal history using the graph theory computation model. (Step 2) Analysis of the predicted thermal history trends to identify heat buildup. (Step 3) Correction of heat buildup by adjusting process parameters layer-by-layer optimized through iterative simulation of the thermal history.

In some implementations, a first step includes predicting thermal history (e.g., temperature distribution) of a LPBF part using a graph theory approach. Such graph theory approaches can include computationally tractable approaches.

In some implementations, a second step includes analyzing one or more predicted thermal history trends and identifying layers where excessive heat buildup is likely to occur. A control target can include a rate of change, or slope, of end-of-cycle surface temperature. The end-of-cycle temperature can include the surface temperature of a part after a layer is deposited and a fresh layer of powder is placed above but prior to melting of the next layer. In some implementations, processors implementing one or more techniques described in this document maintain the slope at 0° C. per layer. In some implementations, control is only initiated when the rate of change of end-of-cycle temperature satisfies a threshold—e.g., exceeds 20° C. per layer, among other values.

In some implementations, a threshold of 20° C. is used. An increase in end-of-cycle surface temperature greater than 20° C. between successive layers has been found to be correlated with build failures, such as distortion and recoater crashes.

In some implementations, a third step includes correcting heat buildup in layers identified in a second step—e.g., by adjusting the laser power layer-by-layer or by increasing the dwell time between layers, thus allowing the part to cool. These processing conditions can be optimized through iterative simulation of the thermal history using a graph theory approach.

The prediction of thermal history and changes to process parameters are guided by a graph theory thermal simulation approach. This mesh-free computational thermal modeling approach converges approximately 7 to 10 times faster than existing non-commercial finite element-based LPBF simulations on a desktop PC, and the thermal history is predicted with error less than 10%.

The computational advantage of the graph theory approach allows practitioners to rapidly iterate and simulate the effect of changing processing conditions on the thermal history before a part is printed. Thus, this model-driven feedforward control strategy can significantly reduce the need for extensive empirical optimization and testing to mitigate flaw formation, and thereby accelerate the time-to-market of LPBF parts.

To demonstrate the effectiveness of the feedforward approach two identical build plates were used. Each build plate consisted of 16 parts encompassing 10 types of geometries parts made from Nickel Alloy 718 material. In the first build plate-fixed processing-all parts are printed under identical, powder manufacturer-recommended processing parameters, and these parameters are maintained constant throughout the process for all layers of the part. Fixed processing can also be referred to as traditional processing.

The second build plate-controlled processing—has identical parts printed under matching conditions except the laser power was changed layer-wise depending on the geometry of each part, and the dwell time between layers was increased to mitigate heat buildup. Preventing heat buildup was the target of the feedforward control approach presented in this demonstration due to its correlation with flaw formation. The parameter changes for the controlled processing case can be optimized a priori through thermal simulations. Each part on the controlled processing build plate is printed with a unique, build strategy aimed at minimizing heat buildup specific to the part geometry.

Post-process the physical properties of parts built under fixed and controlled processing conditions are compared using a variety of ex-situ non-destructive and destructive characterization techniques. Specifically, non-destructive X-ray computed tomography was used for measurement of porosity, surface texture and geometric accuracy. The Archimedes method was used for relative density measurements. Destructive metallography characterization involved optical and scanning electron microscopy, and measurement of microhardness.

In some implementations, controlling the heat buildup at the part-scale is successful at reducing various types of scale-transcending flaw formation, such as microstructure grain size, surface finish, and geometric accuracy. In some implementations, systems for controlled LPBF target scale-specific outcomes—e.g., type and texture of microstructure evolved, residual stresses, and feature resolution, among others. For example, systems can control one or more thermal phenomena, such as cooling rate and spatial thermal gradients. In some implementations, heat buildup is mitigated between layers and within one or more layers. In some implementations, heat buildup is mitigated only between layers.

In some implementations, process parameter adjustment or identification is automated—e.g., through optimization algorithms. For example, optimization algorithms can be used by one or more systems implementing techniques described in this document. The optimization algorithms can be used to identify process parameters, adjust parameters (such as laser power, dwell time between layers, among others). In some implementations, process parameter adjustment or identification is performed based on heuristic techniques or observation.

In some implementations, in contrast to hatch-level temperature control, techniques avoid heat buildup at the overall bulk part-level by adjusting laser power and dwell time between layers. In some implementations, techniques do not rely on high-resolution hatch-level simulations to optimize laser parameters within a layer. For example, techniques can use a rapid and relatively low-resolution graph theory approach. The techniques described demonstrate advantages of feedforward control in the context of four different part shapes with post-process measurements ranging from quantification of microstructure in terms of grain size, surface finish, dimensional integrity, and microhardness.

In some implementations, a hybrid feedforward and feedback control of a LPBF process is used by systems implementing the techniques described to help control the LPBF process. For example, sensor-based feedback control can be augmented with model-based feedforward control to mitigate heat buildup—e.g., based on data from an in-line sensor

The techniques described are scalable to a variety of relatively complex and large, multi-layer parts. The thermal model and effect of feedforward control can be validated through in-situ thermography measurements. The techniques are not restricted to single track and meltpool-scale process control or part-scale thermal modeling

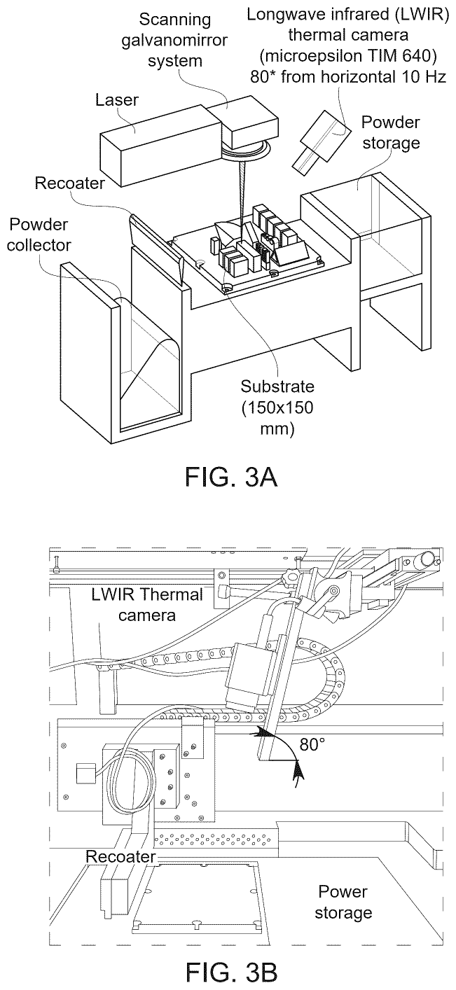

FIG. 3A shows a schematic of an LPBF system. FIG. 3B shows a photograph of an LPBF system. An infrared thermal camera inclined at 80° to the horizontal is included in the chamber. The thermal camera can be configured to monitor a surface temperature of parts during processing.

A schematic and picture of the sensor instrumented LPBF system is presented in FIG. 3A and FIG. 3B respectively; its specifications are provided in Table 1.

TABLE 1
Example process parameter settings and material properties. Also
included are example settings used for an IR thermal camera.

| Process Parameter [Units] | Values |
|---|---|
| Laser type and wavelength. | Ytterbium fiber, wavelength 1070 nm |
| | continuous mode (manufacturer IPG), |
| | 700 W max power |
| Nominal Laser Power (P₀) [W] | 285 |
| Scanning Speed (V) [mm · s⁻¹] | 960 |
| Hatch spacing (H) [mm] | 0.1 |
| Layer thickness (T) [mm] | 0.04 |
| Stripes overlap [mm] | 0.08 |
| Stripe width [mm] | 10 |
| Volumetric global energy density Eᵥ | 73 |
| [W/mm³] | |
| Laser spot size [μm] | 68 |
| Scanning strategy | Meander-type scanning strategy with 45 |
| | degree rotation of scan path between |
| | layers. |
| Build atmosphere | Argon |
| Build plate Preheat temperature [° C.] | 85 |
| Recoater Cycle Time [sec] | 15 |
| Powder Material Properties | Values [units] |
| Material type | Nickel Alloy 718 (Ni718); corresponding |
| | to UNS N07718 (Carpenter Additive) |
| Particle size range [μm] | 15-45 (D10-D90) |
| IR Thermal Camera Specifications | Values |
| Brand and model | Micro Epsilon - thermoIMAGER TIM 640 |
| Resolution [pixels], [pixel per mm²] | 640 × 480, 20 |
| Frame rate [Hz] | 10 |
| Spectral range [μm] | 8 to 14 |
| Spatial resolution of object in image | 20 |
| [μm/pixel] | |
| Camera On trigger event | Laser Start |
| Image size [mm] | 125 × 125 |

The LPBF system shown in FIG. 3A and FIG. 3B allows processing parameters, such as laser power, dwell time between layers, scan path, and laser velocity, among others to be independently altered, layer-by-layer, for each part on the build plate.

In some implementations, the system is equipped with a SCANLABS HurryScan20 galvanometer-mirror scanner, a 700 W 1062 nm Yb-fiber laser (IPG Photonics YLR-700WC) and a precision motion control system (Aerotech A3200) driven by CNC G-code that can be edited by an operator. In some implementations, the system produces a nominal spot size of 68 μm at 370 W-measured by a laser beam profiling system (Ophir BeamWatchAM).

In some implementations, a Micro-Epsilon model pe thermoIMAGE TIM 640 longwave infrared (LWIR) thermal camera with an operating wavelength of 8 to 14 μm is installed inside the machine chamber. In some implementations, the camera is inclined—e.g., at 80° to the horizontal. The camera can acquire data at 10 Hz. In this particular example, the optical resolution of the camera is 640 pixels×480 pixels. Example camera settings are summarized in Table 1. In the example shown in FIG. 3B, the thermal camera is positioned to capture an approximately 125 mm×125 mm central area of the build plate resulting in a spatial resolution ˜20 pixels per mm². The camera was triggered by a G-code command before the laser began scanning a layer and was stopped after the laser completed that layer. Hence, data was only acquired when the laser was actively melting material.

In some implementations, the IR camera measurements are calibrated—e.g., using an absolute temperature with reference contact thermocouple readings or using infrared thermography.

In some implementations, a system for controlled LPBF uses a Hall effect current sensor. For example, the Hall effect current sensor can be connected to the recoater to capture the recoater motion. The sensor can provide an estimate of the recoating time and detects load on the recoater blade, which can be valuable for detecting recoater impact. The time for recoating a layer with fresh powder can be on the order of 15 seconds and can remain fixed irrespective of the process conditions or number of parts on the build plate. In the demonstration of the techniques described, no recoater impact was detected by the Hall effect sensor.

Two build plates with identical parts were created in the demonstration of the techniques described, one termed fixed processing and the other termed controlled processing. The settings for the build plate with fixed processing conditions are reported in Table 1. For fixed processing, nominal process parameter settings for Nickel Alloy 718 material were implemented based on recommendations from the powder manufacturer. These process parameters were optimized to avert porosity. Nickel Alloy 718 was chosen given its wide use in the aerospace and energy generation industries.

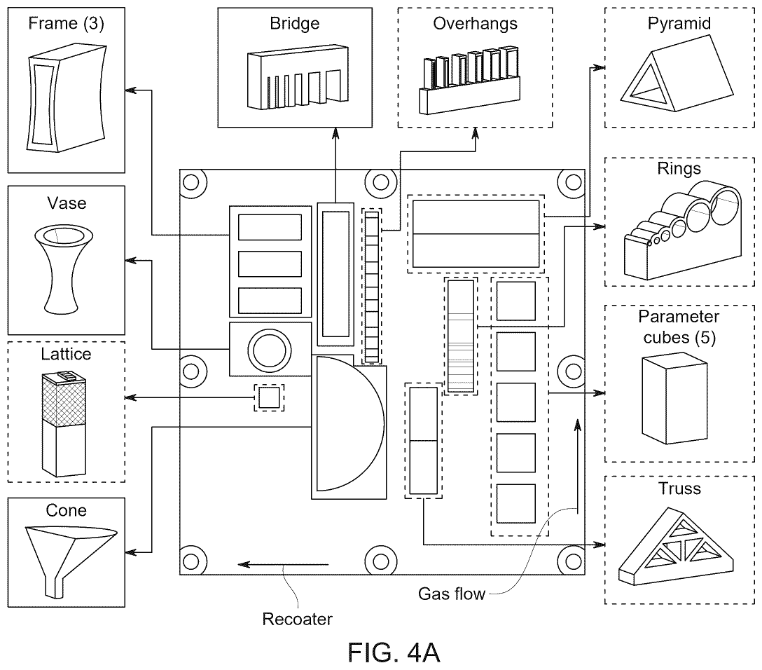

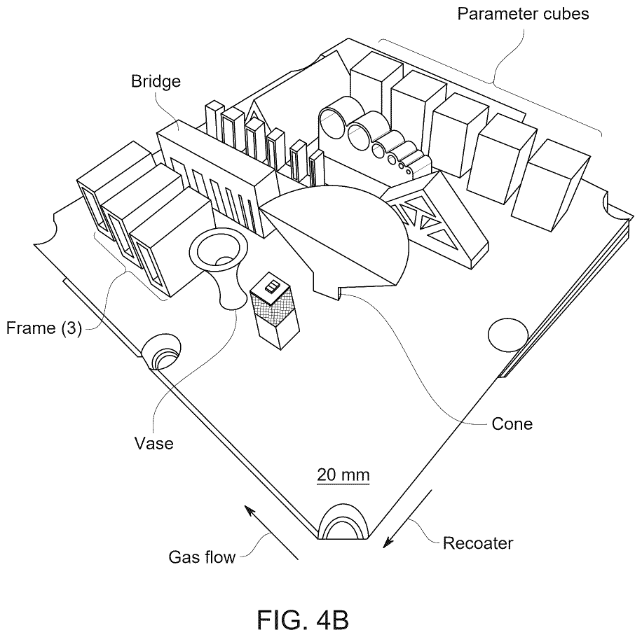

FIG. 4A shows a top view of a build plate with detailed view of geometries created in this work with four geometries analyzed in depth. FIG. 4B shows an actual fixed processing build plate upon completion. FIG. 4A shows a top view of the build plate with detailed view of 16 geometries with cone, vase, frame, and bridge geometries are analyzed in depth. FIG. 4B shows geometries after being created using LPBF processing.

As shown in FIG. 4A and FIG. 4B, each build plate consists of 16 parts encompassing 10 unique types of geometries. All the parts are 25 mm tall to prevent abrupt change in the time between layers resulting from early completion of certain parts, which can cause flaw formation. Parts were placed near the center of the build plate to prevent flaw formation from lens aberrations, and a spacing of ˜10 mm was maintained between parts to reduce the potential for inter-part thermal interaction. Total build time was approximately 15 hours. Additionally, the build plate was preheated to 85° C. to mitigate residual stresses.

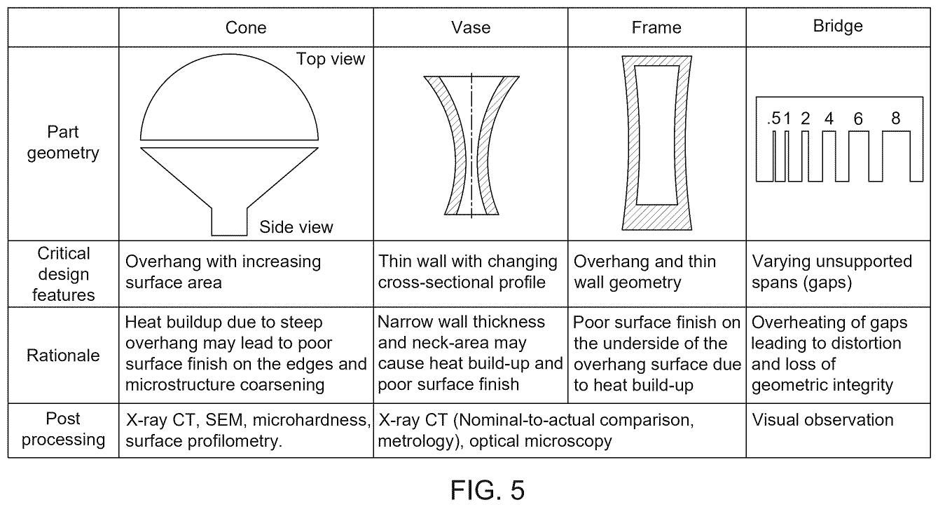

Four representative parts were selected for analysis in this work. Referring to FIG. 4A and FIG. 4B, the parts selected are labeled: cone, vase, frame, and bridge. These four parts were selected for further analysis because their relatively compact size was conducive for post-process X-ray CT analysis and metallurgical characterization. The rationale for the design of these parts is described in FIG. 5 which shows the four parts selected for analysis, their underlying rationale, and post-process characterization.

After the fixed processing build plate was completed, the IR data from the cone-shaped part was used to calibrate the graph theory model. The model predictions can be used to alter the processing conditions for the controlled processing build plate. The model calibration steps along with the approach for altering process parameters for the controlled processing build plate are described in this document.

The X-Y area scanned by the laser can vary substantially over the course of the build. The time between layers (TBL), also called inter-layer time (ILT), varies in proportion to the scanned surface area. The ILT is defined as the time elapsed between the beginning of melting one layer to the beginning of the succeeding layer.

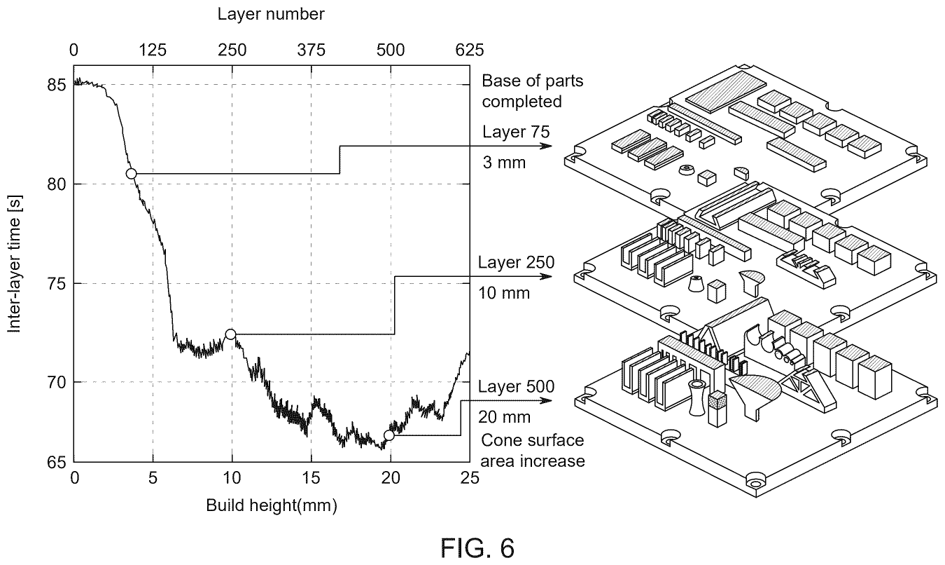

The ILT is obtained from the slicing software before starting the build and verified with data from the recoater current sensor. FIG. 6 tracks the ILT as a function of build height and layers. In this example, ILT varies from 80±5 seconds for the first 5 mm (125 layers) to 70±5 seconds thereafter. The ILT can be included as an input, represented as T[s], in the graph theory model,

$$T ( x , y , z , τ ) = ϕ {e}^{- α g ∧ τ} {ϕ}^{′} {T}_{0} ( x , y , z )$$

described later in the document. In some embodiments, the ILT includes a 15 second constant time to recoat a fresh layer of powder.

In FIG. 6, the first sharp decrease in ILT occurs at 3 mm (layer 75). This decrease was caused by the completion of the large bases of several parts. Another decrease occurs at 10 mm (layer 250), where the surface area of several large parts was reduced. Beyond 20 mm build height (layer 500) the surface area of the cone increases in relation to the other parts, which proportionally increases the time to scan the layer. Therefore, the ILT gradually increases from layer 500 until the build was completed (Layer 625).

After processing, the parts were examined ex-situ using a variety of non-destructive and destructive metallurgical characterization techniques. Non-destructive analysis included X-ray computed tomography (X-ray CT, Nikon XTH-225) for nominal-to-actual metrological analysis, and porosity measurements. The X-ray CT scanning resolution for these parts was 10 μm per voxel. The CT Pro 3D software was used to reconstruct the 3D volumes from the 2D projections acquired from the X-ray CT. The Volume Graphics software (VGSTUDIOMAX 3.3.4) was used for nominal-to-actual part comparison (NAC) and porosity analysis. The porosity content in each part is reported in terms of defect volume ratio (DVR).

In addition, the relative density of the parts was quantified using Archimedes measurements. Relative density is the ratio of the density of the sample compared to a fully dense sample of the same material. Samples with a relative density less than 100% are likely to be affected by porosity or other flaws [55]. The surface roughness of as-built parts was measured using laser scanning microscopy (Keyence VK-X200K). The surface roughness is quantified in terms of the average areal surface roughness (Sa), and is reported as the mean of 6 different sample regions, each of area 1 mm×1.4 mm.

For microstructure characterization, the parts were cross-sectioned using wire electro-discharge machining. The cross-sectioned samples were ground using silicon carbide abrasive paper, polished using diamond paste (3, 1, 0.5 μm) and etched with aqua regia for ˜10 seconds. Subsequently, optical and scanning electron microscopy (Helios 660 NanoLab, FEI) were used to analyze the microstructure. Microhardness measurements (Vickers, H_{V0.5}) were then acquired at 0.5 kg and dwell time of 10 seconds (Tukon 2500 Hardness Tester).

In some implementations, systems used to implement the techniques described calibrate a thermal camera used in the control loop. It can be important to calibrate the thermal camera readings because IR thermography generally provides a relative measurement and not an absolute temperature reading. The temperature measurements captured by the IR camera consider thermal emissivity to be constant. However, emissivity is generally not constant, but depends on the temperature of the body, angle of inclination of the body to the IR camera, and surface finish of the body.

In LPBF, the surface temperature can vary considerably, and the surface texture transforms as the material changes from powder to a consolidated part. Accordingly, LPBF control systems can calibrate to enable conversion of temperature readings obtained by the IR thermal camera to an absolute scale.

One example calibration includes an offline two-point calibration after parts are built to offset emissivity differences between un-melted powder and solid metal parts. Temperature readings from an IR camera can be converted to an absolute scale through direct correlation to temperature recorded by a contact thermocouple welded to two of the five cube-shaped parts which was selected for calibration (see FIG. 4A and FIG. 4B).

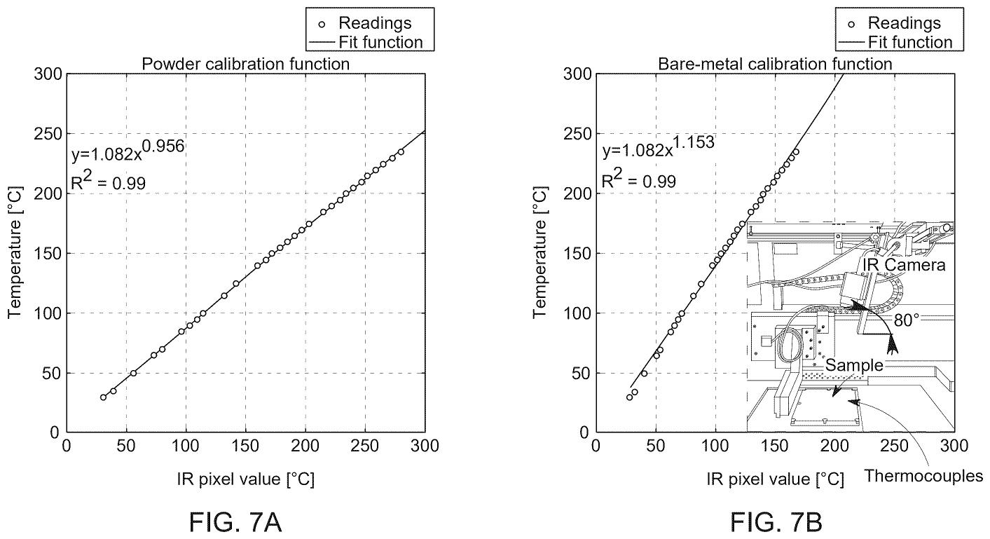

In the example demonstration which included a calibration step, after completing the first fixed processing build, two of the cube-shaped parts (see FIG. 4A and FIG. 4B) were removed from the build plate and a K-type thermocouple was resistance spot-welded to the surface of each part. The parts were placed on a fixture with a cartridge heater, which was bolted on the build plate of the machine. The calibration setup is shown in the inset of FIG. 7 part (b).

The build plate was lowered to place the top surfaces of the cubes at the level of the processing plane and the parts were placed in the same location as would be seen by the IR camera during the actual build, essentially recreating the process conditions inside the chamber during the build. Metal powder was deposited on top of the part to simulate the state of the process before laser melting. This is because the thermal emissivity values of an as-printed LPBF surface and a surface with powder spread on top differ significantly. The temperature of the parts was gradually raised using the cartridge heater and the absolute temperature response of the thermocouple as well as the relative temperature response of the IR camera were recorded. The process was repeated without powder on top of the part to simulate the condition after a layer has been processed.

A calibration function was obtained by fitting a regression function to the recorded data for both the bare-metal and powder-deposited conditions. The result of the calibration and the fitted regression function are presented in FIG. 7 part (a) and (b) for the powder-deposited and bare-metal conditions, respectively. In part (a) a calibration function for powder deposited on the part is shown. In part (b), a calibration function for the bare-metal condition is shown. The inset of FIG. 7 part (b) shows a fixture used for calibration of the temperature readings.

To reduce the effect of measurement noise, the IR reading was averaged over a 9 pixel×9 pixel (180 μm×180 μm) region, centered on each cube. The calibration functions shown in FIG. 7 range from 25° C. to 250° C. Temperature measurements over the upper limit would be inaccurate as it would saturate the IR camera readings. These obtained calibration functions were applied to all IR measurements for this work.

We note that the calibration curves in FIG. 7 are valid for fixed intrinsic and extrinsic status of the IR camera. A change in the intrinsic state of the IR camera, i.e., the various software settings of the camera, such as exposure time, would void the calibration. Likewise, a change in the extrinsic state of the IR camera, i.e., angle of inclination, position, stand-off distance from the build plate, would also invalidate the calibration functions. Given the sensitivity of the sensor to both internal and external settings, using a part-level infrared thermal camera for closed-loop feedback control would further compound measurement errors.

In this work, measurement of the liquidus temperature was not attempted, as the focus is to predict and control the end-of-cycle temperature gradient after solidification, as opposed to local melting phenomena, and moreover, the temperature of the liquid state metal was beyond the saturation range of the camera sensor.

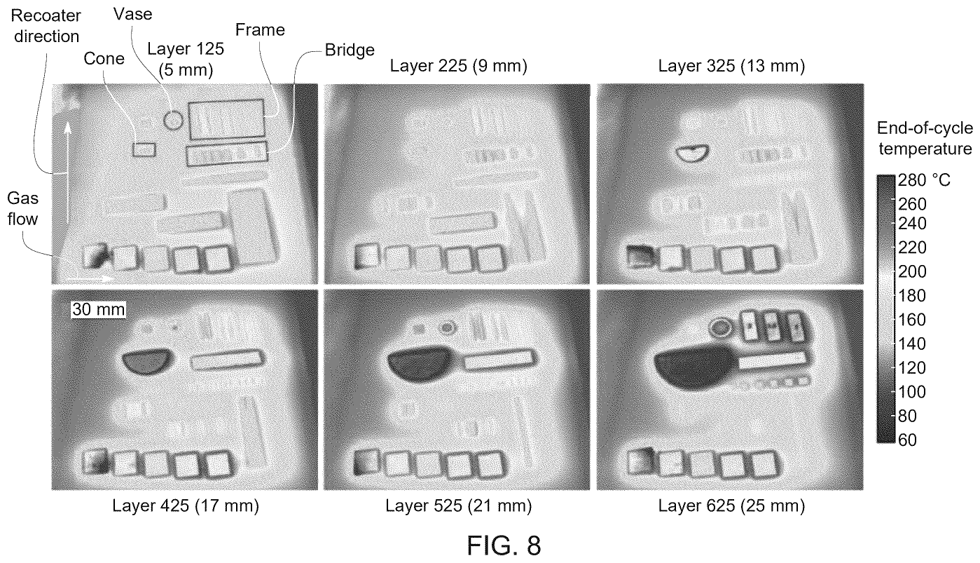

An example of the IR thermal camera images acquired during the fixed processing build are shown at select intervals in FIG. 8. The images of FIG. 8 were taken after a layer is melted. Despite processing with constant processing conditions, the surface temperature during the build varies between parts at the same layer, as well as layer-to-layer for the same part. The scale bar is calibrated to absolute temperature.

The temperature scale bar in FIG. 8 is obtained after applying the calibration function discussed in this document (e.g., by fitting a regression function to the recorded data for both the bare-metal and powder-deposited conditions). These IR images, taken at the end of each layer, visually depict the variation in surface temperature observed in the various parts. For example, despite printing under identical processing conditions, FIG. 8 shows the prominent increase in surface temperature throughout deposition for the cone-shaped part compared to the other parts. Thus, the thermal history varies layer-to-layer for the same part, as well as between parts at the same layer. Hence, to avoid heat buildup, it is necessary to tailor the processing conditions both part-by-part and layer-by-layer.

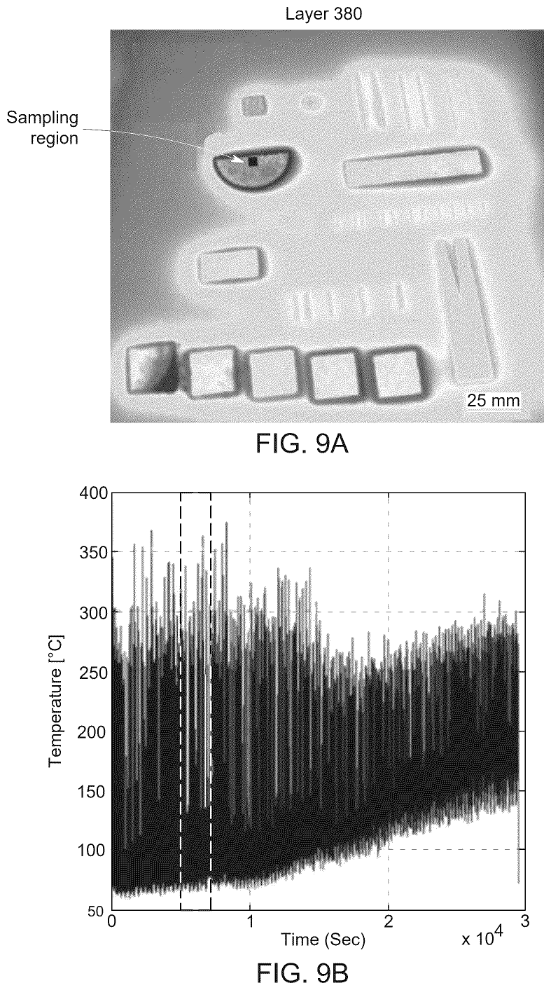

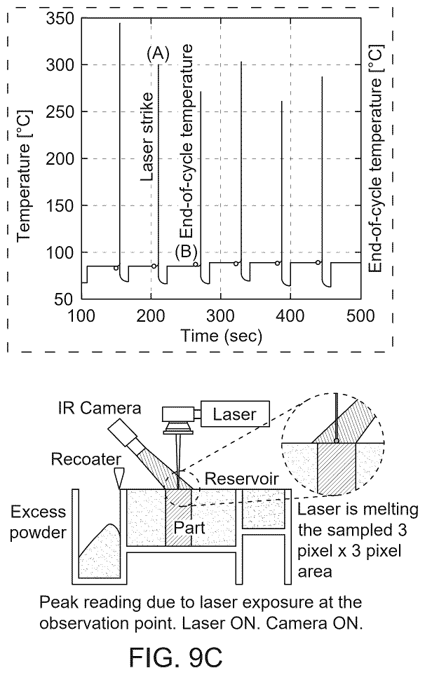

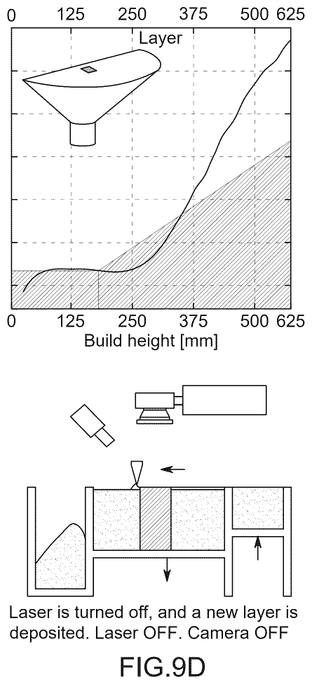

The thermal history of the parts is quantified in terms of the end-of-cycle surface temperature. FIG. 9 shows, in part (a) a 60×60 μm (3×3 pixel) region of interest is selected for each part; (b) The temperature trends for each part plotted with trends for the cone; (c) A zoomed-in view which shows a prominent spike (λ) caused due to laser events depicted in the two pictures; and (d) The end-of-cycle temperature (B) plotted across all layers. End-of-cycle temperature is extracted after a fresh layer of powder is deposited but 0.5 seconds before the next laser strike (λ).

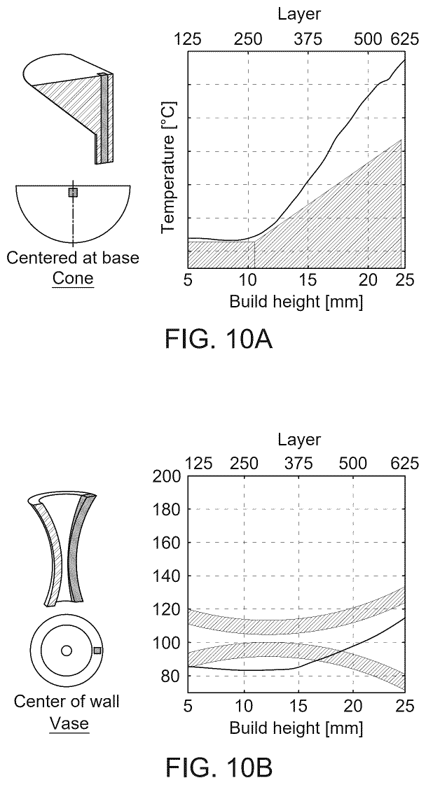

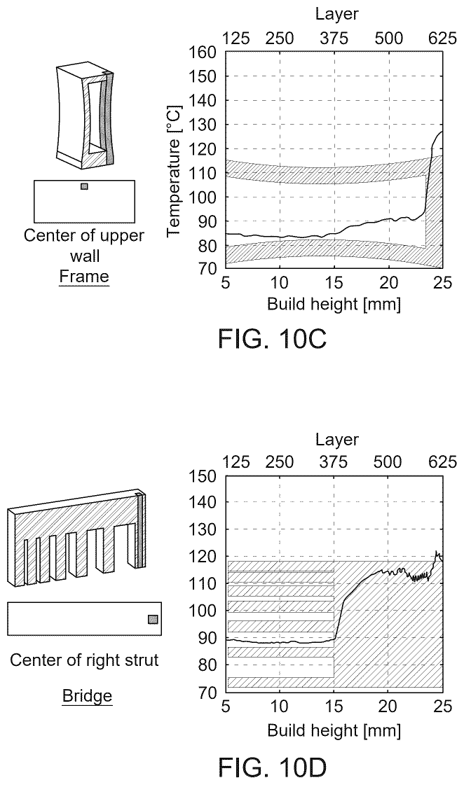

It is the average of the IR camera thermal readings after calibration over a 3 pixel×3 pixel (60 μm×60 μm) region on each part. The end-of-cycle surface temperature is plotted in FIG. 10 for each of the four parts studied in this work. FIG. 10 shows observed surface temperature from IR camera plotted as a function of layer height for: (a) cone, (b) vase, (c) frame, and (d) bridge. Also shown are corresponding locations where surface temperature are reported. A 60 μm×60 μm region of interest corresponding to 3 pixel×3 pixel in the IR camera image is selected for tracking the surface temperature across the layers.

FIG. 9 part (a) shows an example of the selected 3 pixel×3 pixel (60 μm×60 μm) region of interest for the cone part. The surface temperature response for this region of interest over all 625 layers is shown in FIG. 9 part (b). The temperature readings in FIG. 9 part (b) are obtained after converting the IR temperature readings to an absolute temperature scale using the two calibration functions described in this document.

FIG. 9(b) also shows periodic spikes which can be observed. In FIG. 9 part (c), spikes labeled (λ) are caused by the laser scanning over the region of interest on the part. This is followed by a rapid cooling and slight increase after the powder bed is lowered and a new layer of powder is deposited. The rationale is explained in the schematic pictures on the last row of FIG. 9. The end-of-cycle temperature, demarcated at the temporal location (B) in FIG. 9 part (c), is recorded 0.5 seconds before the laser strikes a new layer of powder. The end-of-cycle temperature (B) is plotted as a function of the build layer for the cone-shaped part in FIG. 9 part (d).

The end-of-cycle temperature reported over the 60 μm×60 μm region of interest for each of the four parts is shown in FIG. 10. This region of interest was chosen to enable measurement of thin cross-section regions in the vase and frame parts. Measurements near part edges were avoided to preclude errors due to image blurring between the part and surrounding powder. In FIG. 10, the temperature for the first 5 mm (125 layers) is not reported since the IR thermal camera readings are affected by transients from the cartridge heater used to preheat the build plate.

In FIG. 10 part (a), the end-of-cycle surface temperature for the cone-shaped part increases significantly due to the 45° overhang on the edge. In FIG. 10 part (b) for the vase part, the surface temperature increases after the narrow neck region due to the insulating nature of the powder trapped in the narrow internal cavity, the increase in overall surface area being consolidated, and the thin-wall nature of the part. Similar rapid increases in the end-of-cycle surface temperature for the frame part is evident in FIG. 10 part (c) at the overhanging section at the end of the build from ˜22 mm build height (layer 550) until completion. In the bridge-shaped part (FIG. 10(d)), the surface temperature increases sharply after a build height of 15 mm (layer 375) as the relatively thin legs are poor pathways for conduction of heat trapped by unmelted powder in the gaps.

We note that the surface temperatures reported in FIG. 10 do not exceed 200° C., which is well below the melting point of the material (Nickel Alloy 718, 1600° C.). This is because, as explained in the context of FIG. 9, the end-of-cycle surface temperature is obtained after a new layer of fresh powder has been deposited by the recoater, and 0.5 seconds before this new layer is melted. Since the inter-layer time (ILT) in this work (FIG. 6) was between 65 and 85 seconds, and given the rapid cooling rates observed in LPBF, the end-of-cycle surface temperatures are well under the melting point of the material.

In a heat diffusion equation used in techniques described, the temperature T at a point (x, y, z) at time (t) is,

$$ρ {c}_{p} \frac{\partial T ( x , y , z , t )}{\partial t} - k {\overbrace{( \frac{{\partial }^{2}}{\partial {x}^{2}} + \frac{{\partial }^{2}}{\partial {y}^{2}} + \frac{{\partial }^{2}}{\partial {z}^{2}} )}}^{Laplacian operator} T ( x , y , z , t ) = \frac{P}{v \cdot h \cdot d \cdot {t}_{0}} \qquad ( 1 )$$

The right-hand side of the heat diffusion equation captures the effect of processing parameters such as scan speed (v, [m·s⁻¹]), hatch spacing (h, [m]), laser power (P, [W]), layer height (d, [m]), and characteristic time (to, [s]). The characteristic time is the pulse time of the laser.

The right-hand side is further simplified as

$${E}_{V} = \frac{P}{v \times h \times t \times {t}_{0}} [ W \cdot {mm}^{- 3} ] ,$$

which is called the volumetric energy density and is defined as magnitude of energy supplied by the laser to melt a unit volume of powder.

The left-hand side of the heat diffusion equation includes material properties: density (ρ[kg·m⁻³]), specific heat (cₚ[J·kg⁻¹·° K⁻¹]) and thermal conductivity (k[J·m⁻¹·s⁻¹·° K⁻¹]). The second derivative term in the heat equation,

$$\frac{{\partial }^{2}}{\partial {x}^{2}} + \frac{{\partial }^{2}}{\partial {y}^{2}} + \frac{{\partial }^{2}}{\partial {z}^{2}} ,$$

called continuous Laplacian operator, is expressed in terms of spatial coordinates of the body, and thus captures the effect of part shape on the heat flow.

The heat diffusion equation is solved by adding the following boundary and initial conditions, and by replacing the heat source term E_{V} with an initial temperature distribution T₀(x, y, z). In Eqn. (2), below, the continuous Laplacian operator is represented as ∇² and the thermal diffusivity as

$$α = \frac{k}{ρ {c}_{p}} [ {m}^{2} \cdot {s}^{- 1} ] .$$

$$\frac{\partial T ( x , y , z , t )}{\partial t} - α {∇}^{2} T ( x , y , z , t ) = 0 ( For one heating cycle ) \qquad ( 2 )$$

$$T ( x , y , z , t = 0 ) = {T}_{0} ( x , y , z )$$

$$\frac{\partial T ( x , y , z , t )}{\partial n} = 0 ( On boundary )$$

Shifting the heat source to the initial condition is reasonable for the LPBF where the laser scan is rapid compared to the long dwell time before the next layer is melted. The initial temperature distribution T₀(x, y, z) includes the melting temperature of the material, and the initial temperature in the remainder of the body is the temperature distribution from the previous heating cycle. Initial node temperatures are assumed to be the preheat temperature of the build plate (85° C.).

Lastly, the boundary condition implies no heat is lost to the surroundings from the boundaries of the body;

$$\frac{\partial T ( x , y , z , t )}{\partial n}$$

is the outward normal vector. Heat loss at the boundaries is addressed in a separate step (e.g., step 3) during practical implementation as discussed later.

The graph theory approach approximates the continuous Laplacian with the graph Laplacian matrix L, in effect, ∇²=−L. The solution is obtained by discretizing the heat diffusion equation over N nodes and by replacing the continuous temperature with a discrete temperature vector (T),

$$\frac{\partial T ( x , y , z , t )}{\partial t} + α LT ( x , y , z , t ) = 0 \qquad ( 3 )$$

The above first-order ordinary linear differential equation has the following solution,

$$T ( x , y , z , τ ) = φ {e}^{- α g Λτ} {ϕ}^{′} {T}_{0} ( x , y , z )$$

Eqn. (4) frames the heat diffusion equation in terms of eigenvalues ∧ and eigenvectors φ of the graph Laplacian L; T₀[K] is the input temperature of the model, which is determined by the laser heating and temperature of previously deposited layers; T[s] is the inter-layer time (ILT, FIG. 6); and g is a tunable gain factor [unitless], which controls the rate of heat diffusion.

The graph theory solution in Eqn. (4) is semi-analytic in nature, it is analytic in time and numeric in space. To avoid truncation errors, the entire eigen spectrum consisting of N (number of nodes) eigenvectors (φ) and eigenvalues (λ) are considered. The input temperature (T₀(x, y, z)) is estimated as a function of the laser power (P) as follows.

$${T}_{0} ( x , y , z ) = {T}_{n o m} \times \frac{{P}_{new}}{{P}_{0}} β \qquad ( 5 )$$

Where Tₙₒₘ=1600° C. is the melting temperature of nickel alloy 718 at the nominal laser power of P₀=285 W; P_{new} is the altered laser power, and β=0.95 is a constant. The value of β was obtained through tuning of the graph theory model; it remains constant for all parts on both the fixed and controlled build plates. The value for P_{new} is bounded between 200 W to 370 W. The rationale is to avoid lack-of-fusion porosity on the lower end and keyhole melting on the higher end of the laser power.

The variable for time T in Eqn. (4) serves as the effective time for cooling between laser strikes over the course of the build. Time is bounded from the time of laser strike T=0 to the interlayer time for the experiment (see FIG. 6) for a single layer. The gain factor (g) is added to calibrate the model for the specific machine and material. The value of g=1.7 can be used.

The graph theory approach to thermal modeling has the following advantages compared to traditional finite element analysis (FEA) based techniques in the context of LPBF.

Mesh-free Modeling. The graph theory technique discretizes the part geometry into point nodes and does not need to mesh the part into volumetric elements. Whereas FEA requires repeated meshing and remeshing to simulate layer-by-layer deposition of LPBF, the graph theory model activates discrete nodes, saving computation time.

Matrix inversion-free computation. Unlike FEA, the graph theory solution does not involve cumbersome matrix inversion steps. Instead, the eigenvalues (∧) and eigenvectors (φ) of the Laplacian matrix (L) are used, which further reduces computation time.

Time-step free calculation. The FE approach is a fully numeric computational solution which requires time steps to be small for the solution to converge. The graph theory solution is analytic in time, hence the time step (T) in the graph theory solution, shown in Eqn. (4) can be set to any value without losing precision. Thus, the graph theory simulation does not require stepping through time.

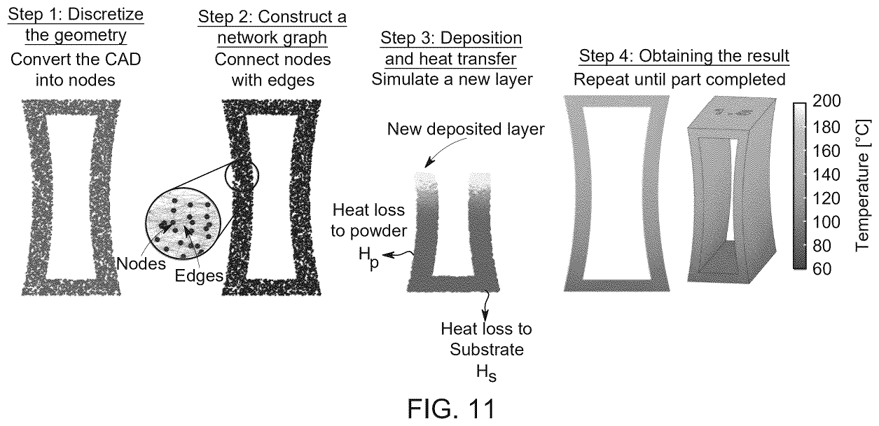

FIG. 11 shows four example steps in the application of the graph theory approach to model the thermal history of LPBF parts. In Step 1, the part geometry is discretized into point nodes. These nodes are sampled with a uniform random distribution throughout the part geometry. FIG. 11 shows an application of graph theory thermal modeling in LPBF with multiple steps in simulating the thermal history of the frame part. A 2D map is shown for explanation purposes, a 3D temperature distribution can be obtained in practice for each layer.

The node density (n, nodes·mm⁻³) can impact the convergence of the model. A higher node density (n) can result in a more accurate convergence, albeit at the expense of computation time. The computation generally scales exponentially (n³) to the number of nodes.

In Step 2, the nodes are connected by edges, whose weight depends on the Euclidean distance to neighboring nodes. From this connectivity information, the Laplacian matrix (L) is obtained, wherefrom the eigenvectors (φ) and eigenvalues (∧) are computed. In step 3, the deposition process is simulated for each layer. Step 3 involves solving the heat conduction equation in Eqn. (1) for a layer using the graph theory approach (Eqn. (4)).

After heat diffusion via conducted, heat loss at nodes on the boundary of the part due to convection and radiation from the part to the surrounding powder, and from the part to the substrate is accounted by applying lumped capacitive theory to the temperature, as follows.

$${T}_{b} = {e}^{- h Δ t} ( {T}_{b i} - {T}_{p} ) + {T}_{p} \qquad ( 6 )$$

Here, the temperature of the surroundings Tₚ is considered as constant, T_{bi} is the boundary node temperature obtained by the heat diffusion alone in Eq. (4), T_{b} is the resulting boundary node temperature incorporating convection and radiation heat loss, Δt is the time step between the calculation of the heat diffusion within a layer, and h[W·m⁻²·° C.⁻¹] is the bulk coefficient of heat loss for convection (via Newton's law of cooling) and radiation (via Stefan-Boltzmann law) from the boundary nodes to the surrounding powder and air. The heat loss coefficient is stratified between part to surrounding powder (h_{w}), and part to substrate (hₛ). In addition to convection and radiation, heat loss via conduction between the part and the substrate is also included in hₛ. After convection and radiation are adjusted at boundary nodes, the temperature at various nodes obtained from graph theory at each node located at position (x, y, z) at time step Δt is T (x, y, z, Δt).

Lastly, in Step 4, Steps 1-3 are repeated as required to simulate the layer-by-layer process. At the end of each iteration, the temperature of the previous layers is carried forward. In other words, residual heat from deposition of previous layers is retained in the nodes. The simulation parameters used in this work are reported in Table 2. At the end of Step 4, the thermal history of all node locations is obtained and recorded. The result is a 3D rendering of the thermal history. The graph theory thermal model used here makes the following simplifying assumptions:

In some implementations, several layers are deposited at once to reduce computation time.

The entire super layer is assumed to be deposited at the input (melting) temperature T₀. The shape and temperature distribution of the laser beam is ignored, and the laser is considered as a point source.

Each part is considered independent from the others on the build plate, and parts are considered insulated from one another. In other words, the temperature of one part does not affect others.

Heat loss through conduction, convection both free and forced, and radiation are considered, however, the effect of latent heat of fusion due to transformation of material from solid to liquid and back to solid is ignored. In other words, meltpool-scale phenomena are ignored.

TABLE 2
Simulation parameters used in the graph theory thermal simulation.

| Simulation Parameters | Values |
|---|---|
| Heat loss coefficient part to powder, h_{w} | 2.8 |
| [W · m⁻² · ° C.] | |
| Heat loss coefficient part to substrate, hₛ | 80 |
| [W · m⁻² · ° C.] | |
| Thermal Conductivity (k) [W · m⁻¹ · ° C.] | 19.47 |
| Density (ρ) [kg · m⁻³] | 8,193 |
| Specific Heat (cₚ) [J · Kg⁻¹ · ° C.⁻¹] | 435 |
| Melting Point (T₀) [° C.] | 1,600 |
| Ambient chamber temperature, Tₚ [° C.] | 85 |
| Characteristic length [mm] | 2 |
| Neighborhood distance (ε) [mm] | 5 |
| Maximum number of nearest neighbors (n) | 6 |
| Superlayer thickness [mm] | 0.5 (12.5 actual layers) |
| Gain factor (g) [unitless] | 1.7 |
| Computational hardware | AMD Ryzen 3970X CPU, |
| | @3.70 GHz with |
| | 128 GB RAM. |

To utilize the graph theory thermal modeling approach (Eqn. 4), three modeling parameters can be calibrated: the gain factor (g), the number of nodes (n), and super-layer thickness(s). The super layer or meta layer assumption, where several layers are assumed to be deposited at once, can be used in thermal simulations of LPBF to speed computation. The data obtained for the cone-shaped part was chosen for model calibration. Based on previous work for the same material, the gain factor was fixed as g=1.7 [unitless].

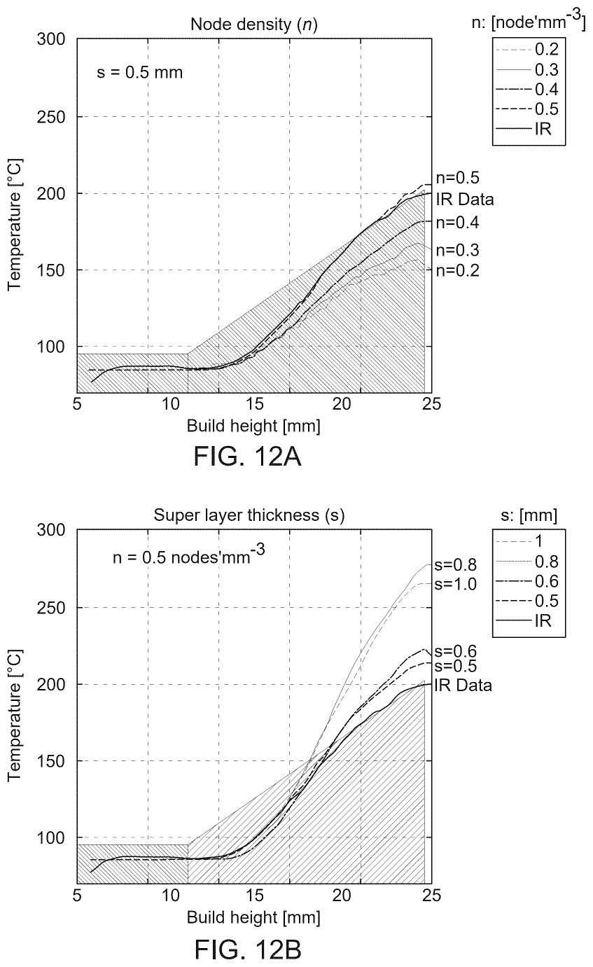

The graph theory solution was obtained for various values of node density (n) and super layer thickness(s) and compared with the IR data. The error with respect to the IR data is reported in Table 3 in terms of the mean absolute percentage error (MAPE, %), and root mean squared error (RMSE, ° C.). The values of n and s resulting in the least MAPE, and RMSE are selected. The effect of node density (n) with s=0.5 mm on convergence is shown in FIG. 12 part (a) and Table 3 (a). Likewise, the effect of layer thickness(s) with node density n=0.5 nodes·mm⁻³ is shown in FIG. 12 part (b) and Table 3 (b).

Referring to FIG. 12 part (a) and Table 3 (a), increasing the node density (n) results in accurate convergence at the cost of computation time. Similarly, from FIG. 12 part (b) and Table 3 (b), reducing the super layer thickness(s) improves the model accuracy, but involves a tradeoff in computation speed. Based on extensive offline tuning, in this work we select n=0.5 nodes·mm⁻³ and s=0.5 mm (Table 2). With these settings, the MAPE and RMSE with respect to the end-of-cycle surface temperature measurements for the cone-shaped part are 1.16% and 4.5° C., respectively, and the simulated thermal history was computed in under five minutes on the desktop computer specified in Table 2.

TABLE 3

| Node Density (n) | | | | | | | n = 0.5 | |
|---|---|---|---|---|---|---|---|---|
| (node · mm⁻³) | n = 0.2 | | n = 0.3 | | n = 0.4 | | (selected) | |
| MAPE (%) | 5.42 | (1.05) | 4.73 | (1.24) | 3.44 | (0.95) | 1.16 | (1.01) |
| RMSE [° C.] | 24.0 | (4.6) | 19.7 | (5.4) | 13.2 | (3.8) | 4.5 | (3.5) |
| Average Run Time [s] | 83 | | 140 | | 221 | | 305 | |
| Layer Size | s = 0.5 | | | | | | | |
| (s (mm) | (selected) | | s = 0.6 | | s = 0.8 | | s = 1.0 | |
| MAPE (%) | 1.16 | (1.01) | 2.46 | (2.93) | 5.50 | (2.93) | 5.67 | (3.05) |
| RMSE [° C.] | 4.5 | (3.5) | 14.5 | (15.3) | 62.7 | (16.3) | 39.2 | (19.9) |

| | | | | |
|---|---|---|---|---|
| Average Run Time [s] | 305 | 208 | 184 | 141 |

(a) Convergence results for the graph theory model as a function of node density (n), the super layer height was fixed at s = 0.5 mm.
(b) Convergence results for the graph theory model as a function of super layer thickness with node density was fixed at n = 0.5 node · mm⁻³.
The number in parenthesis is the std. dev over 10 iterations.

In FIG. 12, the IR measurements are used as ground truth, and plotted in in black. In part (a) of FIG. 12 the effect of changing node density (n) with super layer thickness fixed at s=0.5 mm is shown. In part (b), the effect of super layer thickness(s) with number of node n=0.5 nodes·mm⁻³ is shown.

Techniques described implement a feedforward control approach. The feedforward control approach can be a heuristic feedforward control approach or optimized using one or more optimization or control algorithms—e.g., for controlling or identifying process parameters.

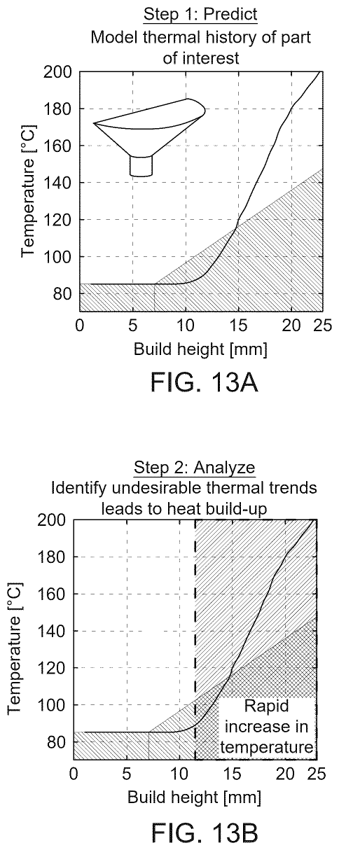

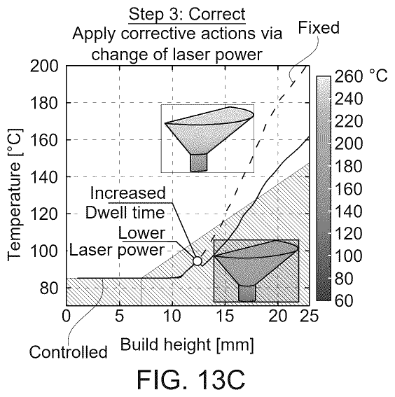

In some implementations, a technique for feedforward control includes three steps. For example, feedforward control can include: (Step 1) predict; (Step 2) analyze; and (Step 3) correct. The approach is summarized in FIG. 13 in the context of the cone-shaped part. FIG. 13 shows a model-driven feedforward control of additive manufacturing approach applied to a cone-shaped part. FIG. 3 shows each of three steps including: (Step 1) Prediction—The graph theory thermal model is used to predict the thermal history of the part; (Step 2)—Instances of rapid increases in temperature (heat buildup) are identified from analysis of the thermal history predictions; and (Step 3)—Thermal history is corrected to avoid steep temperature gradients and heat buildup by changing the laser power.

First, in Step 1, the thermal history of the part is predicted using nominal processing conditions. As depicted in FIG. 13 part (a), it is observed that the end-of-cycle surface temperature increases rapidly after 12 mm of build height (layer 350). In this work, an increase in end-of-cycle surface temperature greater than 20° C.—an example threshold-between successive super layers was considered as a potential onset of heat buildup. Based on this criteria, in Step 2 (analyze, FIG. 13 part (b)), the surface temperature after 12 mm (300 layers) is flagged as a point of heat buildup.

In Step 3, the steep rise in end-of-cycle surface temperature was remedied by reducing the laser power and increasing the dwell time between layers. For this purpose, the thermal history was simulated iteratively using the reduced laser power as an input for the graph theory model. An increase in dwell time is considered and tested in the simulation, only if decreasing the laser power to 185 W does not mitigate heat buildup.

For this work, it was determined that the laser power should be maintained within +30% of the nominal laser power (P₀=285 W) to ensure suitable levels of consolidation and density; these limits translate to 200 W (−30% P₀) and 380 W (+30% P₀). These bounds were based on the porosity and relative density analysis results from five cube-shaped parts (10×10×25 mm) shown in FIG. 5 and can be adjusted depending on implementation, along with other parameters and settings described in this document.

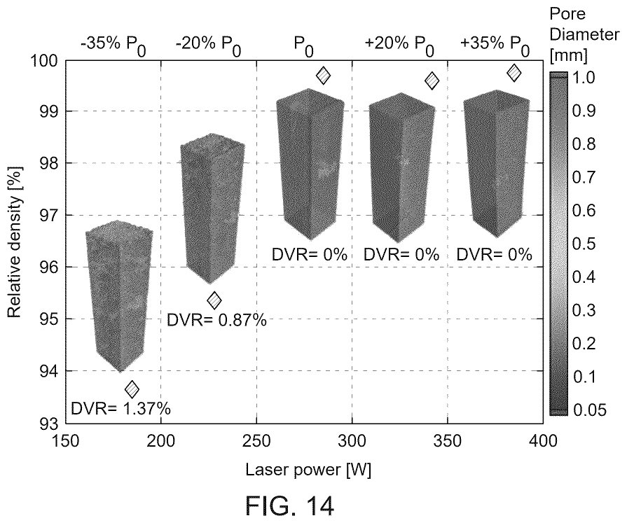

Each of the cubes were printed with varying laser power levels while the rest of the processing parameters were identical to the parameters listed in Table 1. The laser power levels tested were, 385 W (+35% P₀), 342 W (+20% P₀), 285 W (P₀), 228 W (−20% P₀), 185 W (−35% P₀). The parts were examined using X-ray CT and validated using the Archimedes method of density measurement. The porosity in the samples, in terms of the defect volume ratio (DVR), and the results of the Archimedes relative density measurements (ρᵣₑₗ), are presented in FIG. 14.

FIG. 14 shows porosity levels (DVR) from X-ray CT and relative density (ρrel) from Archimedes measurements are plotted as a function of laser power (P) used for five the parameter cubes (see FIG. 5). The nominal laser power, P0=285 W. Severe lack-of-fusion porosity is observed when reducing laser power to 185 W (−35% P0). Hence in this work, the minimum allowable laser power reduction for controlled processing was set to 200 W (−30% P0). The maximum allowable power was set to 380 W (+30% P0) to avoid overheating and keyhole melting. None of the four parts studied in this work, created either in fixed or controlled conditions, showed presence of porosity.

Lack-of-fusion porosity was observed when the laser power was set to 228 W (−20% P₀), resulting in a 0.87% DVR and ρᵣₑₗ=95.3%; the lack-of-fusion porosity becomes severe at 185 W (−35% P₀) with a DVR of 1.37% and ρᵣₑₗ=93.6%. Consequently, to avoid severe lack-of-fusion porosity during the model-driven feed forward control approach, the lower limit for laser power was found to be −30% P₀=200 W. To reduce overheating and keyhole mode operation, the upper limit for laser power was found to be +30% P₀=370 W.

As evidence of the suitability of these laser power bounds and other constant processing parameters, none of the parts studied in this work, either produced under fixed or controlled processing conditions, showed evidence of lack-of-fusion porosity when examined with non-destructive X-ray CT and destructive metallography.

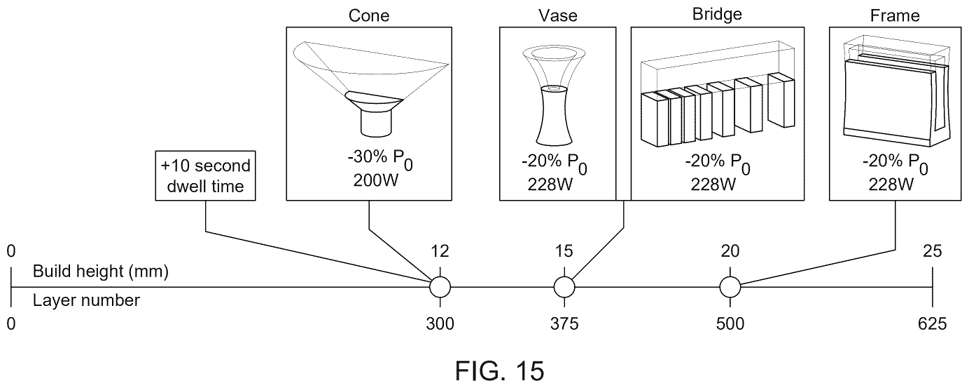

Having established the upper and lower limits of laser power for Nickel Alloy 718 in the context of porosity, each part was simulated iteratively as a function of laser power and dwell time. The control target is the rate of change of end-of-cycle temperature, and is set at 0° C./layer. The control is initiated when the rate of change (slope) exceeds 20° C./layer—in some implementations, other thresholds are used—e.g., 15° C./layer or 25° C./layer. For ease of practical implementation, the dwell time and laser power in the demonstrative work were changed only once for each of the four parts, since these parameter changes are manually implemented by altering the G-code. The laser power and dwell time alterations for controlled processing of each of the four parts is unique and summarized in FIG. 15.

FIG. 15 shows a summary of process parameters adjusted for controlled processing of the four parts. In the given example, once the laser power is reduced at a layer it is maintained until the end of processing.

As an example, referring to FIG. 13 part (c), in the graph theory simulations the laser power for the cone-shaped part was reduced to 200 W from 285 W beginning at layer 300 (build height 12 mm). The reduced laser power was maintained until the end of layer 625 (25 mm). However, it was predicted that the steep increase in temperature of the cone-shaped part would not overcome despite reducing the laser power to 200 W (−30% P₀).

Decreasing the laser power below 200 W would risk severe lack-of-fusion porosity. Consequently, a 10 second dwell time was added to the inter-layer time (ILT) after the first 12 mm (300 layers) of build height. Likewise, for the vase and bridge-shaped parts, the power is reduced to 228 W from layer 375 onwards (15 mm). Similarly, the laser power for the frame was reduced to 228 W from layer 500 (20 mm) onwards.

While addition of a dwell time between layers can mitigate heat buildup, it also affects the thermal history of all the parts on the build plate. Moreover, increasing dwell time increases the production time. For example, adding a 10 second dwell time after each layer from layer 300 onwards until layer 625 increased the build time by 1 hour to approximately 16 hours. Hence, from a productivity perspective the addition of the dwell time must be utilized sparingly. The thermal history, as a result of reduced laser power (200 W) and increased dwell time, is shown in FIG. 13 part (c).

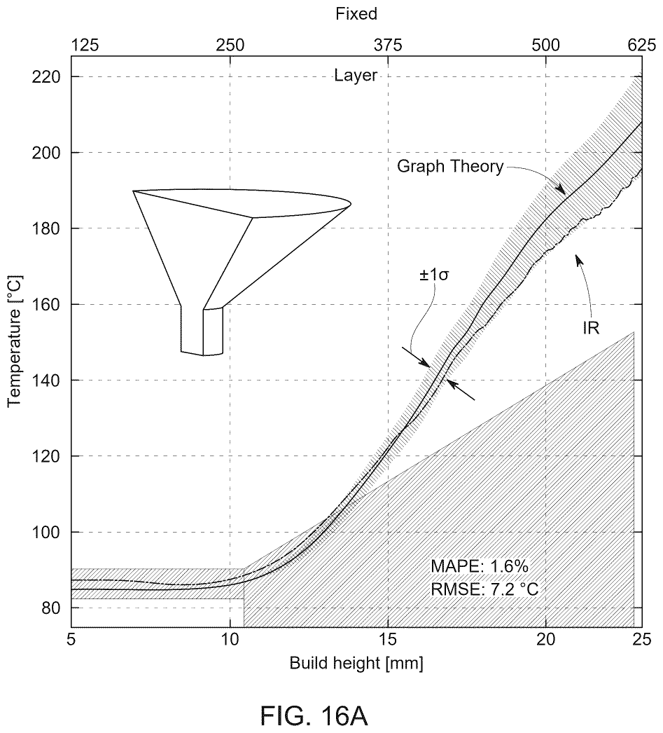

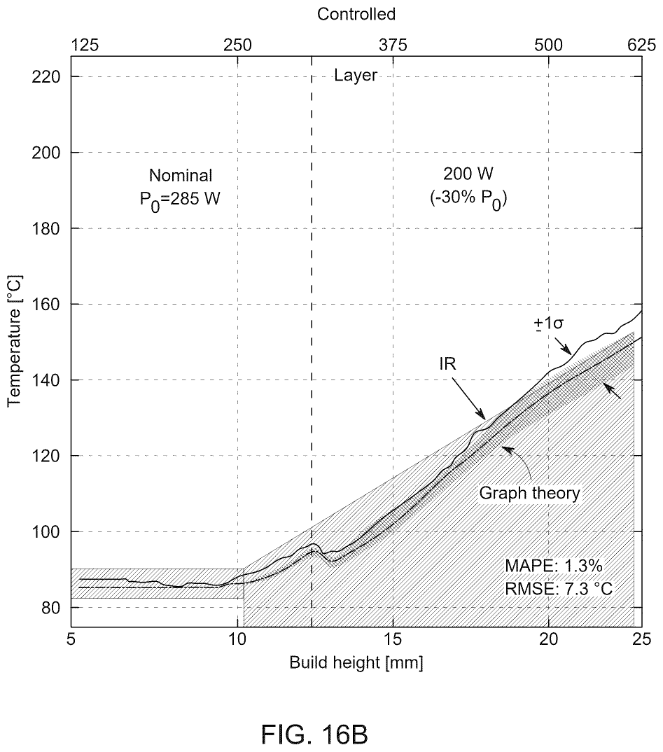

In FIGS. 16(a) and (b), respectively, the model-derived end-of-cycle surface temperature trends are compared to the IR-measured end-of-cycle surface temperature measurements for the cone-shaped part produced under fixed and controlled processing. The significant increase in the end-of-cycle top surface temperature for the fixed-processed cone beyond layer 300 (12 mm), evident in FIG. 16(a), is accurately predicted by the graph theory model (MAPE 1.6%, RMSE 7° C.). Moreover, the simulation required approximately 4 minutes (234 seconds) of computation time.

In FIG. 16, predicted surface temperature trends are overlaid on IR derived observation of the cone for: (a) fixed processing, (b) controlled processing. There is a steep increase in temperature in (a) compared to (b) after ˜12 mm build height (layer 300). These simulations required less than 4 minutes of computation time with error less than 2% (MAPE). The graph theory simulation is repeated 10 times and the ±1σ prediction bands are plotted. The gray area in the background represents the shape of the part in terms of the build height.

The controlled processing of the cone involved reducing the laser power at layer 300 (12 mm build height) to 200 W from 285 W. Further, the recoater dwell time is increased by 10 seconds from layer 300 onwards. In FIG. 16(b), these two aspects substantially arrested the end-of-cycle surface temperature increase for controlled processing. Consequently, the end-of-cycle surface temperature is restricted to a maximum of 150° C. (FIG. 16(b)) for the controlled processing condition, compared to 200° C. for fixed processing (FIG. 16(a)).

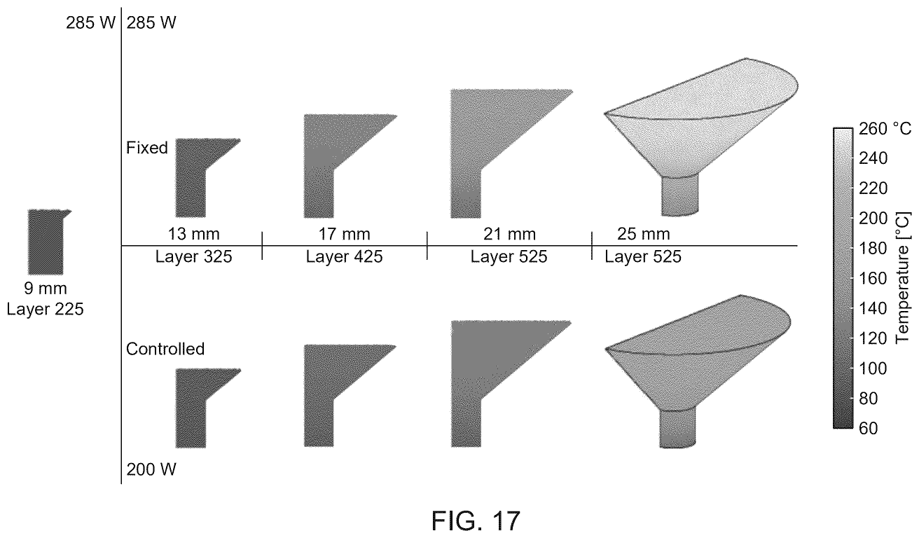

The simulated spatial temperature distribution for the fixed and controlled processing of the cone-shaped parts at select layers is graphically compared in FIG. 17. In accordance with the temporal thermal history trends discussed in the context of FIG. 16, controlled processing significantly reduced the heat buildup in the bulk part. Further, the spatial temperature gradient of the controlled-processed part is relatively smaller compared to its fixed-processed counterpart.

FIG. 17 shows a spatial temperature distribution for the cone part predicted using the graph theory thermal model for fixed processing (top) and controlled processing (bottom). In controlled processing heat buildup and spatial temperature gradients can be significantly reduced by decreasing the laser power to 200 W from layer 300 onwards.

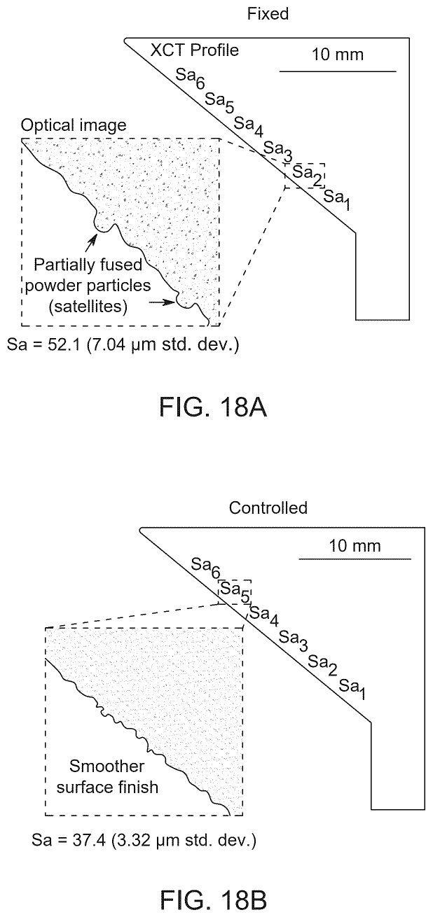

The reduction in surface temperature, as well as the spatial temperature gradient achieved on account of controlled processing (see, e.g., FIG. 16(b)) can have a significant impact on: part surface finish, microstructure grain size, and microhardness. For example, shown in FIG. 18 is an X-ray CT slice of the two cones, along with an optical microscope image of the slanted overhang edges. Part (a) shows a result of fixed processing indicating a rougher surface finish (Sa≈52 μm) due to partially fused particles (e.g., satellites) attached to the overhang edge. Part (b) shows a result of a controlled-processed cone indicating a smoother surface finish (Sa≈37 μm) without satellite particles.

Both samples had no detectable levels of porosity using X-ray CT, resulting in a DVR of 0.00%. In the case of the fixed-processed cone, FIG. 18(a), the excessive heat buildup caused partially melted satellite powder particles to adhere to the overhang edge. However, the occurrence of satellite powder particles is mitigated for the controlled-processed cone (FIG. 18(b)).

As a result of partially melted powder adhered to the surface, the average areal surface roughness (Sa) at the overhang edge for the fixed-processed cone was assessed to be Sa≈52 μm compared to Sa≈34 μm for the controlled-processed cone. The foregoing areal surface roughness measurements are averaged over 6 sample regions spaced along the overhang section (demarcated with Sa in FIG. 18), each region having an area of 1 mm×1.4 mm. No lack-of-fusion porosity was observed in FIG. 18 for either the fixed-processed or controlled-processed cone.

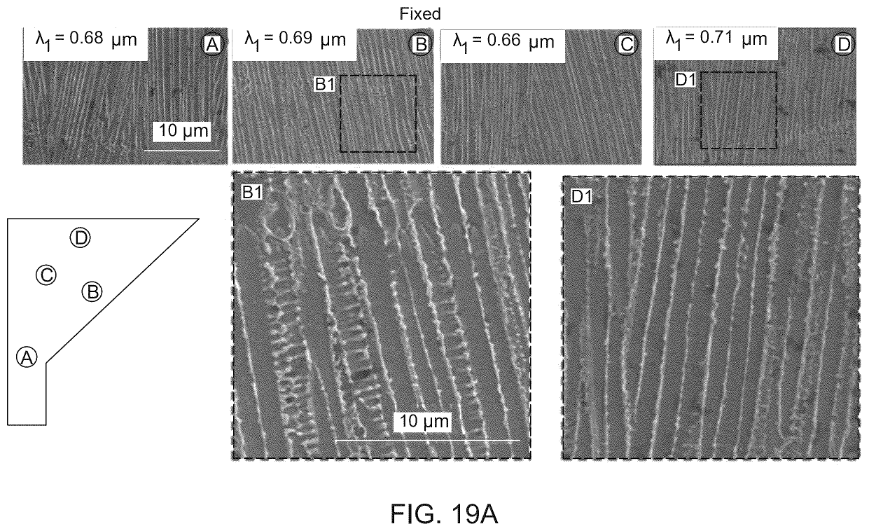

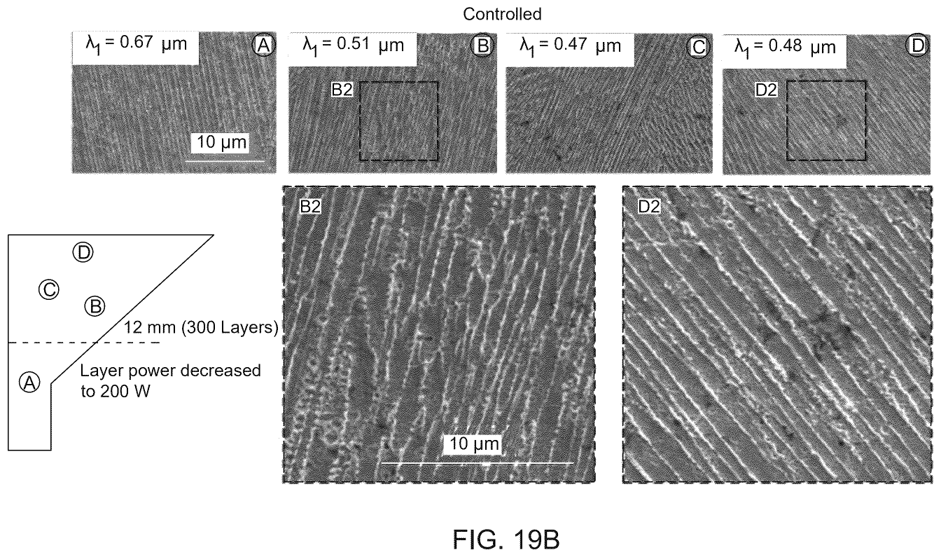

The effect of temperature distribution on the microstructure of the fixed and controlled processing cone-shaped parts is presented in FIG. 19. The mean primary dendritic arm spacing (λ1) for the fixed processing part was λ1˜0.65 μm compared to λ1˜0.50 μm for controlled processing after the laser power was reduced to 200 W at layer 300 (12 mm) and a dwell time was increased by 10 seconds.

It was anticipated that heat buildup and an increased spatial temperature gradient in the fixed-processed cone-shaped part would result in larger grain size compared to the controlled processing parts. After cross-sectioning the parts with electro-discharge machining and polishing and etching the surface as described herein, the microstructure was examined at different locations using scanning electron microscopy (SEM).

To quantify the grain size, the primary dendritic arm spacing (λ₁) was measured. The primary dendritic arm spacing (λ₁) is inversely proportional to the cooling rate, and hence provides an indirect means to verify the effectiveness of the controlled processing. These measurements were made over a length of 20 μm, perpendicular to the dendrite growth direction. Four of the locations where the primary dendritic arm spacing (λ₁) was measured is visualized in FIG. 19. These locations are demarcated as A, B, C, and D.

Until the 300-layer mark (12 mm), both the controlled and fixed-processed samples were measured to have λ₁˜0.68 μm. However, after the laser power is changed from 285 W to 200 W at layer 300 (12 mm), λ₁ at locations for the controlled samples were consistently smaller than their fixed-processed counterparts. The λ₁ for the controlled-processed samples (200 W) was measured to be 0.49 μm+0.02 μm (FIG. 19(b)). By contrast, for fixed processing (285 W), FIG. 19(a), λ_{1=0.69} μm±0.02 μm. Indeed, enlarged images of the overhang locations in FIG. 19(a) show the presence of secondary dendrites in the fixed-processed samples, symptomatic of excessive heat buildup.

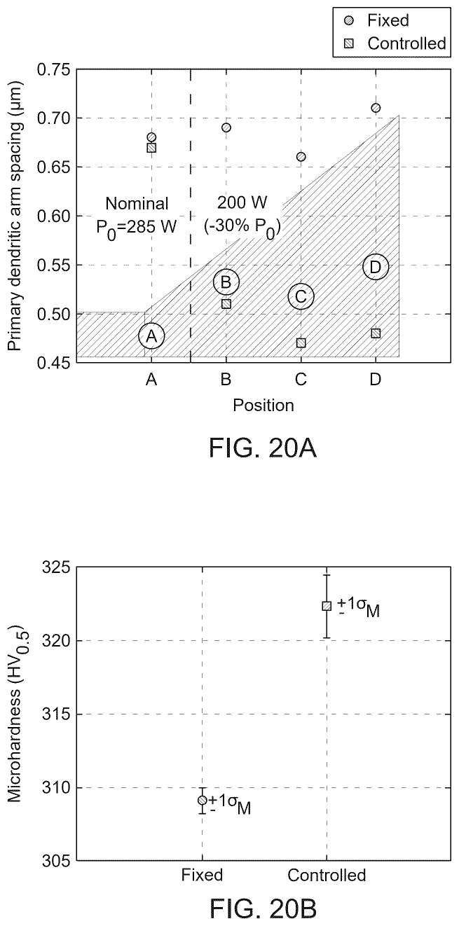

Continuing with the analysis, λ₁ measured for the four locations A, B, C, D are plotted in FIG. 20(a). Part (a) of FIG. 20 shows primary dendritic arm spacing (λ₁) for controlled processing (blue) and fixed processing (red) conditions at the four positions A-D demarcated in FIG. 19. Reduction in laser power for sections B-D during controlled processing results in finer grain structure (smaller λ₁). Part (b) indicates the microhardness (HV0.5) is inversely related to λ₁—the larger the grain size, smaller the microhardness.

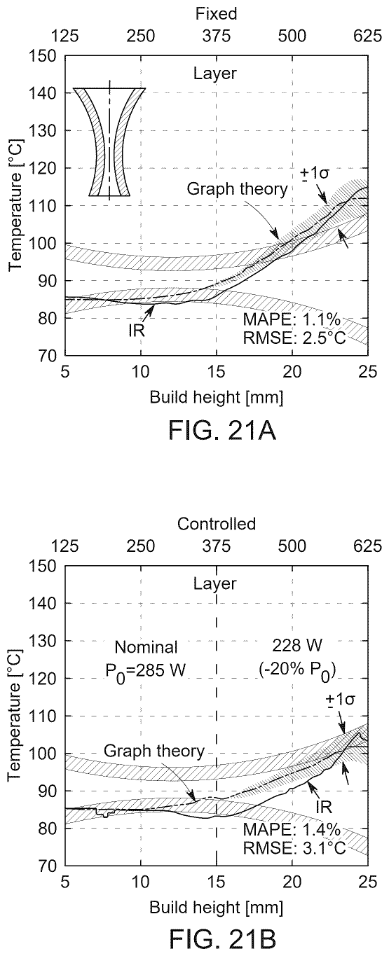

While the difference in end-of-cycle surface temperatures between the fixed and controlled-processed vases shown in FIG. 21 are smaller compared to those between the cone-shaped parts (e.g., FIG. 16), the relatively complex shape of the vase produces a pronounced effect on the geometric integrity.

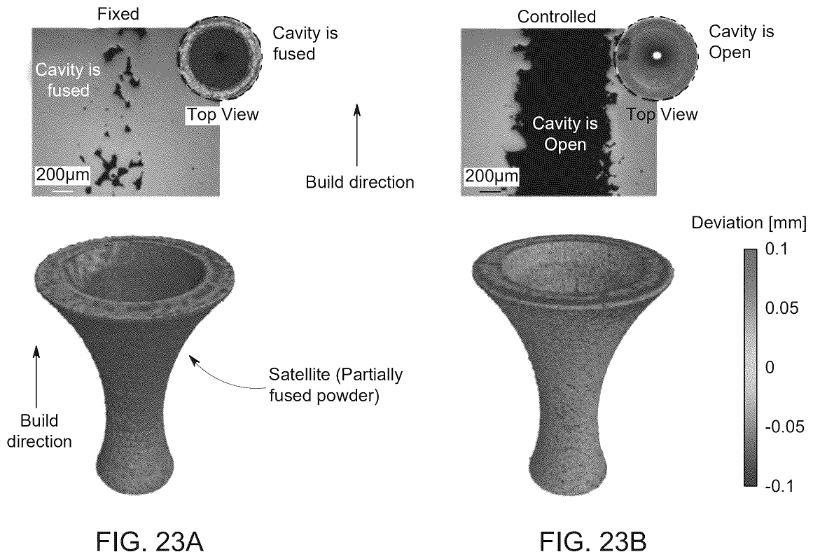

FIG. 23, on top, shows optical cross-section micrographs and, on bottom, shows nominal-to-actual X-ray CT dimensional analysis of the vase-shaped parts. Part (a) indicates fixed processing where the central cavity of the vase is fused and has satellite particles adhered to the internal and external surfaces on account of overheating. The nominal-to-actual dimensional computation to CAD (from X-ray CT analysis) reveals that the fixed-processed vase has a positive deviation larger than 0.1 mm consistent with over-melting of powder. Part (b) indicates the controlled-processing where the resulting control processed cone has an intact cavity, negligible satellite powder adhered to the surface, and minimal deviation from the design dimensions.

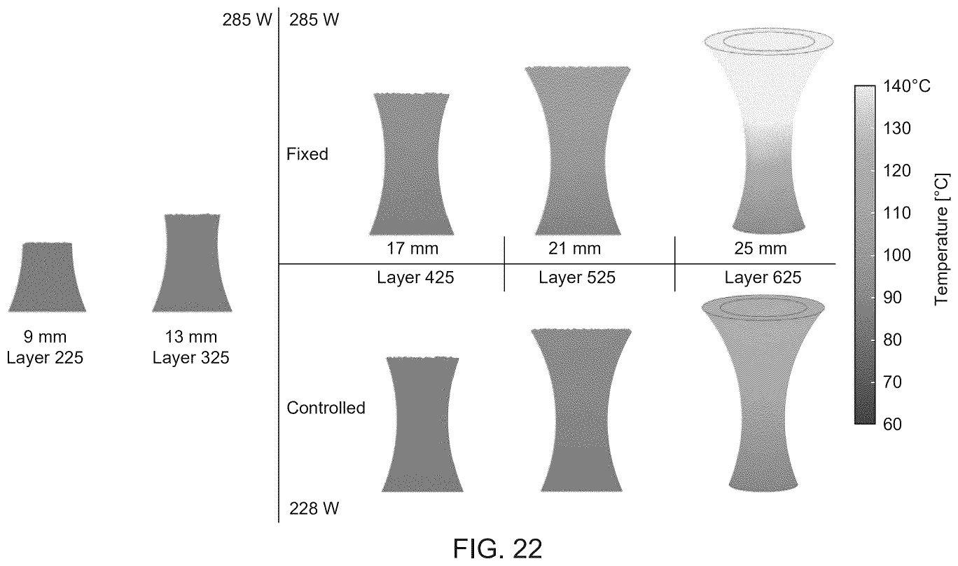

In FIG. 23(a), it is evident visually, and subsequently affirmed on cross-sectioning the part parallel to the build direction, that the central cavity of the fixed-processed cone is sintered closed. This is because the elevated bulk part temperature, especially in the narrow neck region, during fixed processing (FIG. 22) fuses the powder trapped within the cavity. By contrast, as shown in FIG. 23(b) the central cavity for the controlled-processed vase is intact.

Further, in FIG. 23, dimensional analysis conducted from a nominal-to-actual comparison of the CAD model and from X-ray CT measurements revealed that the outer surface of the fixed-processed vase is larger than its nominal CAD model; the deviation exceeds+0.1 mm for the majority of the surface. The positive deviation, shown in a red hue on the figure, indicates that the part is larger than the CAD model. Also, in FIG. 23(a), partially fused satellite powder was adhered to the inner, as well as the outer, surfaces of the fixed-processed vase. By contrast, the vase produced under controlled processing maintains its geometric integrity (FIG. 23(b)) and is largely free of partially fused satellite particles adhered to the surface.

Comparison of the thermal history in FIG. 21 suggests there is less than a 15° C. difference in the end-of-cycle surface temperature between the fixed and controlled processing cases. By contrast, the corresponding difference for the cone was more than 50° C. (FIG. 16). Despite this relatively smaller difference in end-of-cycle surface temperature, the controlled processing sample has an intact cavity, while the cavity is blocked for the fixed processing case.

As seen from the spatial temperature distribution map in FIG. 22, reducing the laser power in higher layers beyond 15 mm build height (layer 375) during controlled processing not only decreased the surface temperature of the current layer, but also diminished the extent of reheating in preceding layers and the overall heat flux through the bulk part.

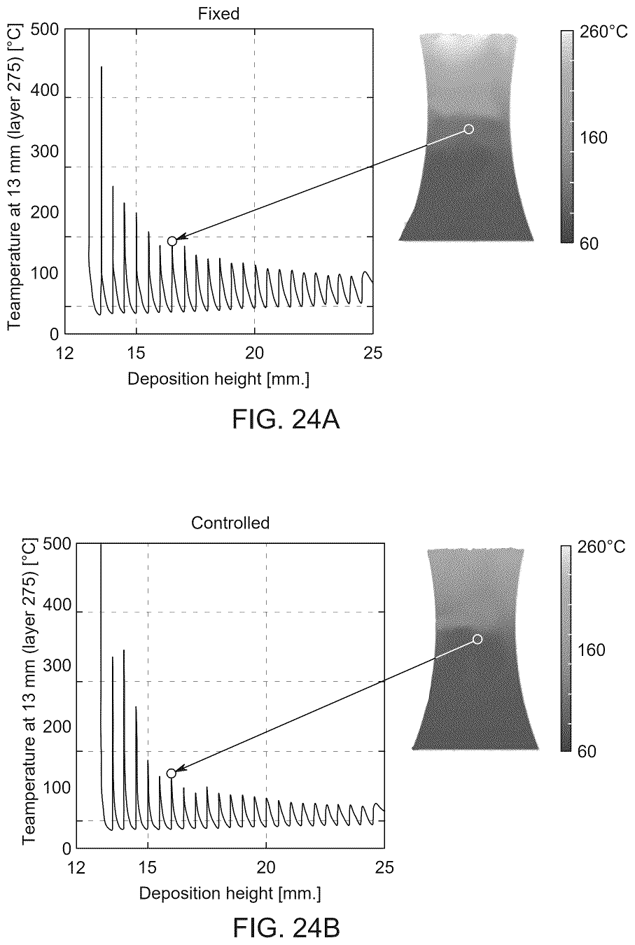

The increased temperature of the previous layers in fixed processing is evident in FIG. 24, where the thermal history is tracked at a specific location on the surface of the part at a build height of 13 mm (layer 325). FIG. 24 indicates that the controlled processing described in this document reduced the temperature in previous layers compared to fixed processing thus mitigating melting of powder trapped in the cavity.

Each peak in FIG. 24 corresponds to the melting of the subsequent layers above. The image shown in the inset of FIG. 24 is the predicted spatial temperature distribution at layer 325 when layer 425 is being deposited. In FIG. 24(a), the elevated bulk temperature of the fixed-processed vase melts the powder trapped in the cavity. Controlled processing (FIG. 24(b)) reduces the bulk temperature, and consequently mitigates over-melting of powder particles within the cavity.

The foregoing observation underscores the importance of controlling the thermal history of not just the topmost layer, but also that of the bulk part. Such control of the bulk part temperature would not be feasible using purely reactive feedback process control mechanisms based on infrared thermal camera measurements of only the part end-of-cycle surface temperature.

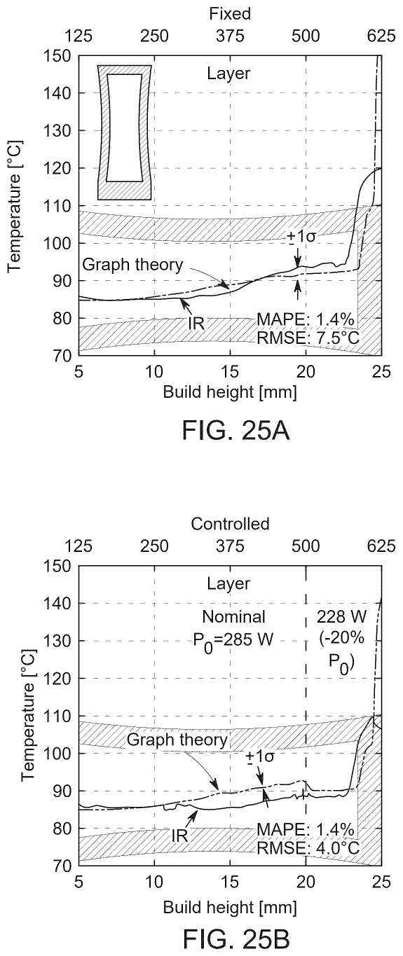

The graph theory simulated thermal history prediction and the experimentally observed surface temperature trends for the frame parts are shown in FIG. 25. The steep increase in temperature observed in the last 2 mm of build height near the top of the fixed-processing case in (a) is mitigated in the controlled processing case (b) by reducing the laser power to 228 W from the nominal 285 W. The simulation was calculated within 10 minutes with error less than 2% (MAPE). The ±1σ prediction interval is shown for both cases.

For the fixed processing condition (FIG. 25(a)), a rapid increase in surface temperature was observed towards the last 2 mm of the frame part (layers 575 to 625) during melting of the horizontal overhang section at the top. Heat buildup in the overhang region occurs due to the restricted thermal conduction pathway—the powder contained within the hollow frame acts as an insulator and impedes heat transfer to the build plate.

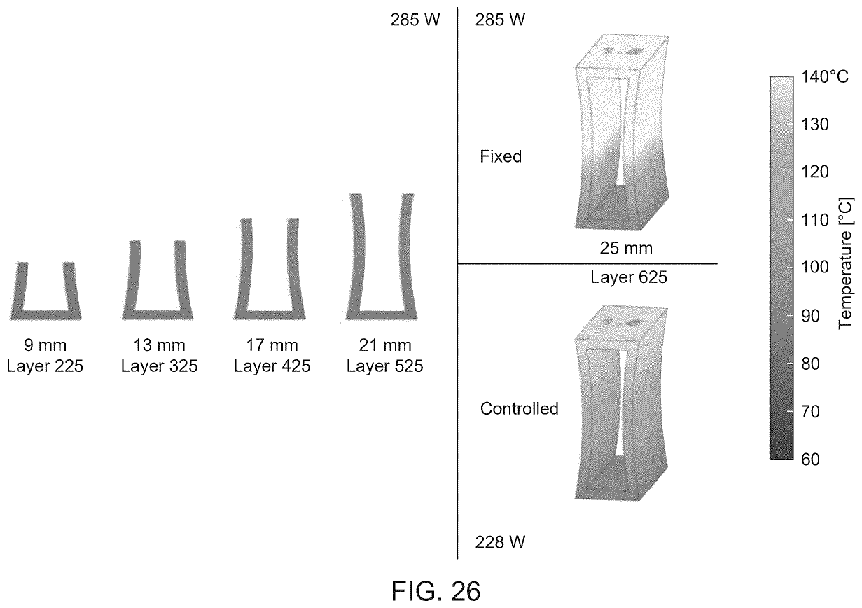

To counteract this sharp increase in temperature of the overhang region, in the controlled processing frame, the laser power is reduced to 228 W for the last 5 mm of processing (layer 500 to 625). The resulting thermal history derived from the graph theory simulation and observed from the infrared thermal camera are shown in FIG. 25(b). Wherein the error between the simulated and observed thermal history is within 1.5% (MAPE) and the predictions were obtained in less than 10 minutes (557 seconds). The steep heat buildup toward the last 2 mm in the fixed-processed part is visually corroborated in the spatial thermal simulation snapshots shown in FIG. 26—in FIG. 26 the reduction of laser power to 228 W in the controlled processing sample beyond 20 mm build height (layer 500) mitigated heat buildup, and resulted in a smaller variation in the spatial temperature gradient. As in previous cases, controlled processing reduces the bulk part temperature, and the spatial temperature gradient.

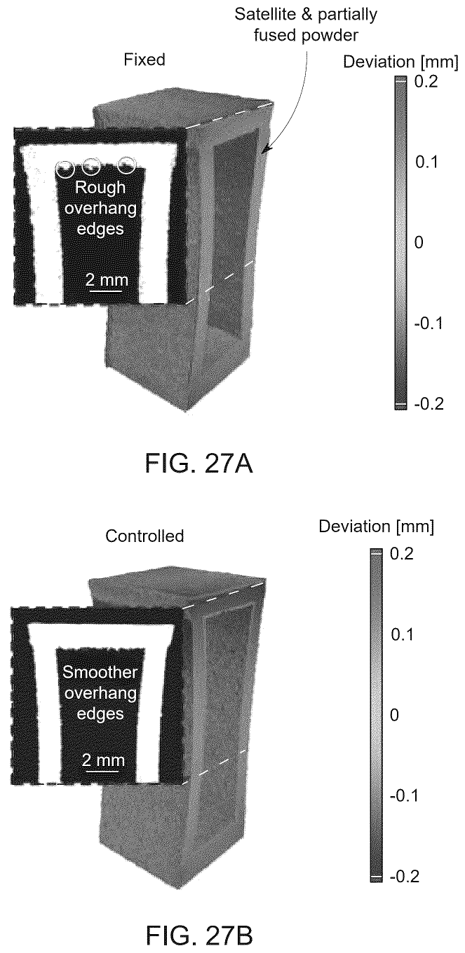

The result of the controlled processing strategy on geometric integrity for the frame is shown in FIG. 27. In the case of fixed processing (a), the overhang region has satellite particle adhered to the part underside, and the external surfaces are symptomatic of heat buildup. These result in relatively degraded overall dimensional integrity and rougher surface finish on the underside of the overhang. In contrast, the controlled-processed frame (b) has improved surface finish and resolution in the overhang region.

The increased temperature in the fixed-processed part causes geometric inaccuracies and inferior surface finish. From the X-ray CT dimensional analysis of the fixed-processed frame in FIG. 27(a), the poor resolution of the overhang region is evident.

Further, satellite particles from partially melted powder are adhered to the inner and outer surfaces of the part. For the controlled processing condition, shown in FIG. 27(b), these geometry and surface flaws are reduced significantly.

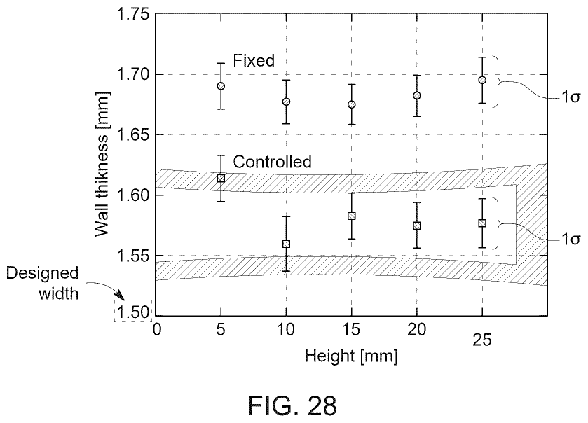

Further, the wall thickness of the two frame parts was measured from the X-ray CT slices. In FIG. 28, the nominal designed wall width was 1.5 mm. The wall thickness for the controlled-processed sample was 1.57 mm, and 1.68 mm for the fixed processing case.

As observed in FIG. 28, the mean wall thickness of the fixed-processed frame part is ˜1.68 mm, viz., 0.18 mm larger than the designed thickness of 1.5 mm. In contrast, the mean wall thickness for the controlled processing is ˜1.57 mm, i.e., a deviation of only 0.07 mm from the nominal.

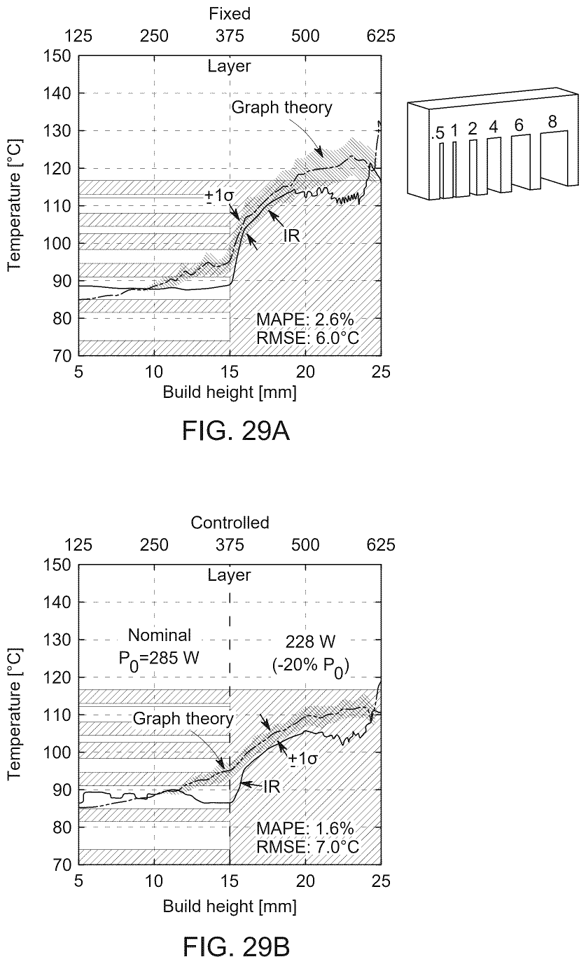

FIG. 29 shows a comparison of the model derived surface temperature trends and IR data for (a) fixed processing, and (b) controlled processing. Note the steep increase in thermal history in (a) beyond 15 mm (325 layers) due to un-melted powder in the gaps which act as a thermal insulator. This steep increase in surface temperature is mitigated by reducing the laser power to 228 W. The simulation converged in a little over 2 minutes (122 seconds) with error less than 2.5% (MAPE). The ±1σ prediction interval is shown for both cases.

The comparison of the predicted and observed thermal history for the fixed and controlled-processed bridge-shaped part are shown in FIGS. 29(a) and (b) respectively. The temperature in the bridge part after 15 mm build height (layer 375) increases considerably due to the insulating properties of the un-melted powder beneath the overhang span regions.

In the case of the controlled-processed part, at layer 375 and beyond the steep increase in temperature is mitigated by reducing the laser power to 228 W (from 285 W). For example, at layer 500 (20 mm build height) the steady state end-of-cycle surface temperature for the fixed-processed bridge exceeds 120° C. (FIG. 29(a)) compared to ˜100° C. (FIG. 29(b)) for the controlled-processed part. These surface temperature trends are accurately predicted by the graph theory approach (MAPE <3% and RMSE ˜7° C.). The simulation converged in just over 2 minutes.

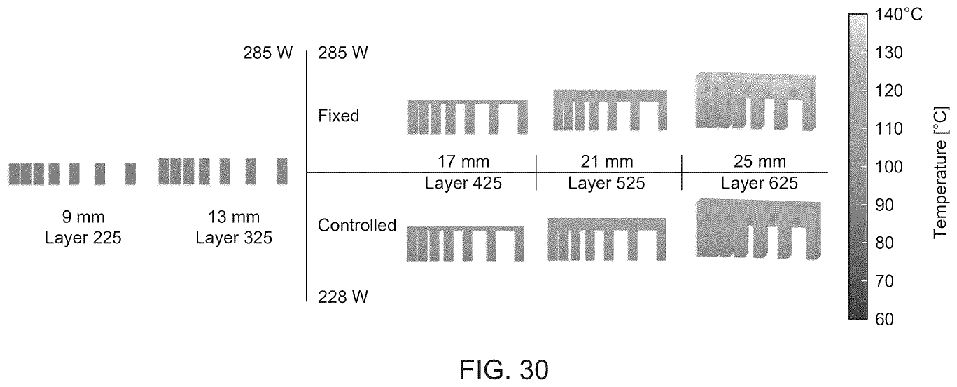

The foregoing temporal thermal history trends are corroborated in the spatial temperature distribution plots in FIG. 30. FIG. 30 shows a comparison of the thermal history for fixed and controlled processing for the bridge. The laser power is reduced to 228 W at layer 375 (15 mm) for the controlled processing condition, and consequently, the steep increase in temperature in the overhang span region is reduced.

A significant heat buildup in the bulk part is noted for the fixed processing scenario, particularly in the region of the overhang sections of the bridge. Controlled processing substantially suppresses the heat buildup in the overhang span.

The differences in the temperature distribution of the bridge part produced under fixed and controlled processing, translate into prominent differences in geometric integrity. The gap between each of the six spans between the legs is assessed visually using optical microscopy.

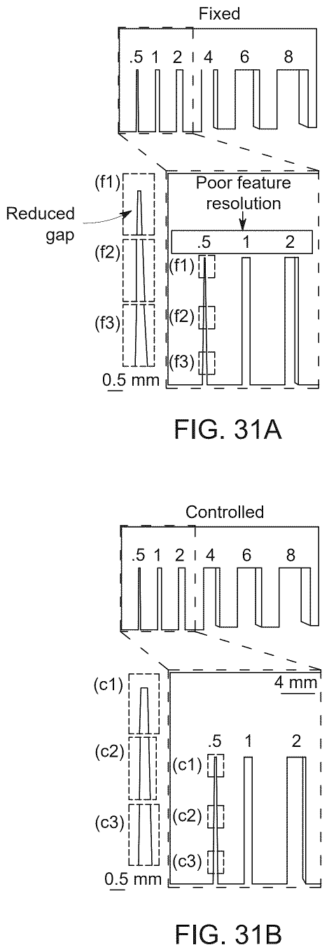

FIG. 31 shows a comparison of the geometric resolution of (a) fixed and (b) controlled-processed bridge part. The geometric resolution of the controlled processing bridges is superior in terms the gap between the legs as well as the engraved numbering.

Visual examination of the fixed and controlled-processed parts, as shown in FIG. 31, reveals that compared to controlled-processing, for the fixed processing condition, the finest 0.5 mm gap was smaller than designed and the resolution of the inset lettering is inferior. The reduction in the gap in the fixed-processed sample is due to over-melting of powder trapped underneath the span (similar to the vase and frame parts) on account of the elevated bulk part temperature.

In one aspect, this document describes a model-driven feedforward control to mitigate heat buildup and prevent subsequent flaw formation in parts made using the laser powder bed fusion (LPBF) additive manufacturing process. As opposed to printing the entire part at a constant parameter set, techniques described in this document can be used to adjust two process parameters, e.g., laser power and dwell time between layers, to mitigate heat buildup based on predictions from a computational thermal model.

The effectiveness of the process parameters optimized based on the feedforward control approach was demonstrated by printing two build plates, each consisting of Nickel Alloy 718 parts of 10 different types of geometries. Extensive post-process characterization was conducted on these parts to quantify their microstructure, microhardness, surface finish, and geometric integrity. It was observed that feedforward control produced parts with finer grain size, improved geometric integrity and resolution, and reduced surface flaws.

From an industry vista, using this approach, practitioners can anticipate potential quality issues due to heat buildup in the part before it is printed, and accordingly modify (optimize) the processing parameters or part design. Such a proactive, physics-aided process parameter and design optimization approach can significantly reduce the need for expensive build-and-test experiments, and thus accelerate the time-to-market of additively manufactured parts.

In some implementations, the feedforward approach is automated. For example, potential regions of heat buildup can be identified and corrected autonomously during the process planning stage through purpose-built algorithms-such algorithms may use a broader scope of control variables, e.g., control variables including laser power, dwell time, laser movement speed, among others. In some implementations, instead of broad strategies of reducing heat buildup across layers, techniques focus on controlling specific process outcomes, such as residual stresses and microstructure heterogeneity.

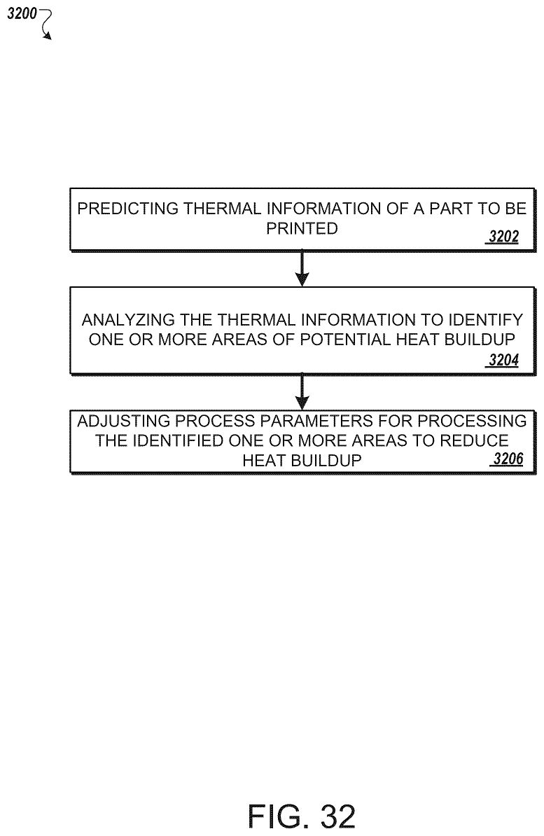

FIG. 32 is a flow diagram of an example process 3200 for controlled laser powder bed fusion (LPBF) metal additive manufacturing. For example, the process 3200 can be used by the LPBF system shown in FIG. 3A or FIG. 3B, among others.

The process 3200 includes predicting thermal information of a part to be printed (3202). For example, as described in reference to FIG. 13, one or more computers of an LPBF system can use one or more graph theory thermal models to predict a thermal history of a part.

In some implementations, predicting the thermal information of the part that is to be printed includes generating a result using a graph theory-based thermal model, wherein the result represents the thermal information of the part.

In some implementations, the process 3200 includes generating the graph theory-based thermal model, where generating the graph theory-based thermal model includes: determining nodes representing portions of the part; and generating one or more values, included in the graph theory-based thermal model, representing one or more connections between the nodes. In some implementations, the thermal information includes one or more temperature distributions.

The process 3200 includes analyzing the thermal information to identify one or more areas of potential heat buildup (3204). For example, instances of rapid increases in temperature can be identified—e.g., by a computing system of an LPBF system—from analysis of thermal history predictions. In some implementations, the one or more areas of potential heat buildup include a layer of the part. In some implementations, the areas of potential heat buildup include areas that satisfy a threshold temperature difference.

In some implementations, the threshold temperature difference is measured between a current layer of the part and a successive layer of the part. In some implementations, the threshold temperature difference is at least twenty degrees Celsius.

The process 3200 includes adjusting process parameters for processing the identified one or more areas to reduce heat buildup (3206). For example, by adjusting one or more process parameters—such as dwell time or laser power, among others-one or more computers of the LPBF system can correct thermal history to avoid steep temperature gradients and heat buildup.

In some implementations, adjusting the process parameters for processing the identified one or more areas to reduce heat buildup includes adjusting the process parameters during a laser powder bed fusion additive manufacturing process. In some implementations, during a laser powder bed fusion additive manufacturing process includes between manufactured layers. In some implementations, the process parameters include a power level of a laser for a laser powder bed fusion additive manufacturing process. In some implementations, the process parameters include a time delay representing a time between manufacturing layers in a powder bed fusion additive manufacturing process.

In some implementations, the part is at least partially printed before predicting the thermal information. For example, in a LPBF system implementing the process 3200, a part can be printed—e.g., using a controlled processing technique described in 3200 or uncontrolled process—and a computing system of the LPBF system can predict thermal information of the partially printed part to inform subsequent adjustments to process parameters during manufacturing of the part.

The order of operations in the process 3200 described above is illustrative only, and can be performed in different orders. For example, one or more computers implementing the process 3200 within a LPBF system can predict thermal information while adjusting one or more process parameters for LPBF manufacturing. In some implementations, the process 3200 can include additional operations, fewer operations, or some of the operations can be divided into multiple operations.

A number of implementations have been described. Nevertheless, it will be understood that various modifications may be made without departing from the spirit and scope of the disclosure. For example, various forms of the flows shown above may be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular implementations of the invention have been described. Other implementations are within the scope of the following claims. For example, the operations recited in the claims, described in the specification, or depicted in the figures can be performed in a different order and still achieve desirable results. In some cases, multitasking and parallel processing may be advantageous.

What is claimed is:

1. A method for feedforward control of a laser powder bed fusion additive manufacturing process, the method comprising:
predicting thermal information of a part to be printed;
analyzing the thermal information to identify one or more areas of potential heat buildup; and
adjusting process parameters for processing the identified one or more areas to reduce heat buildup.

2. The method of claim 1, wherein predicting the thermal information of the part that is to be printed comprises:
generating a result using a graph theory-based thermal model, wherein the result represents the thermal information of the part.

3. The method of claim 2, comprising generating the graph theory-based thermal model, wherein generating the graph theory-based thermal model comprises:
determining nodes representing portions of the part; and
generating one or more values, included in the graph theory-based thermal model, representing one or more connections between the nodes.

4. The method of claim 1, wherein the thermal information includes one or more temperature distributions.

5. The method of claim 1, wherein the one or more areas of potential heat buildup comprise a layer of the part.

6. The method of claim 1, wherein adjusting the process parameters for processing the identified one or more areas to reduce heat buildup comprises:
adjusting the process parameters during a laser powder bed fusion additive manufacturing process.

7. The method of claim 6, wherein during a laser powder bed fusion additive manufacturing process comprises between manufactured layers.

8. The method of claim 1, wherein the areas of potential heat buildup include areas that satisfy a threshold temperature difference.

9. The method of claim 8, wherein the threshold temperature difference is measured between a current layer of the part and a successive layer of the part.

10. The method of claim 9, wherein the threshold temperature difference is at least twenty degrees Celsius.

11. The method of claim 1, wherein the process parameters comprise a power level of a laser for a laser powder bed fusion additive manufacturing process.

12. The method of claim 1, wherein the process parameters comprise a time delay representing a time between manufacturing layers in a powder bed fusion additive manufacturing process.

13. The method of claim 1, wherein the part is at least partially printed before predicting the thermal information.

14. A system comprising one or more computers and one or more storage devices on which are stored instructions that are operable, when executed by the one or more computers, to cause the one or more computers to perform operations comprising:
predicting thermal information of a part to be printed;
analyzing the thermal information to identify one or more areas of potential heat buildup; and
adjusting process parameters for processing the identified one or more areas to reduce heat buildup.

15. One or more non-transitory computer storage media encoded with instructions that, when executed by one or more computers, cause the one or more computers to perform operations comprising:
predicting thermal information of a part to be printed;
analyzing the thermal information to identify one or more areas of potential heat buildup; and
adjusting process parameters for processing the identified one or more areas to reduce heat buildup.

16. The system of claim 14, wherein predicting the thermal information of the part that is to be printed comprises:
generating a result using a graph theory-based thermal model, wherein the result represents the thermal information of the part.

17. The system of claim 16, wherein the operations comprise generating the graph theory-based thermal model, wherein generating the graph theory-based thermal model comprises:
determining nodes representing portions of the part; and
generating one or more values, included in the graph theory-based thermal model, representing one or more connections between the nodes.

18. The system of claim 14, wherein the thermal information includes one or more temperature distributions.

19. The system of claim 14, wherein the one or more areas of potential heat buildup comprise a layer of the part.

20. The system of claim 14, wherein adjusting the process parameters for processing the identified one or more areas to reduce heat buildup comprises:
adjusting the process parameters during a laser powder bed fusion additive manufacturing process.
